(19) United States
(12) Patent Application Publication
(10) Pub. No.: US 2019/0303281 A1
(43) Pub. Date: Oct. 3, 2019

(54) SURVIVABILITY GUARANTEES FOR MEMORY TRAFFIC

(71) Applicants: Amin Firoozshahian, Mountain View, CA (US); Vedaraman Greetha, Fremont, CA (US); Andreas Kleen, Portland, OR (US); Stephen Van Doren, Portland, OR (US); Omid Azizi, Redwood City, CA (US); Mahesh Madhav, Portland, OR (US); Mahesh Maddury, Santa Clara, CA (US); Chandan Egbert, San Jose, CA (US)

(72) Inventors: Amin Firoozshahian, Mountain View, CA (US); Vedaraman Greetha, Fremont, CA (US); Andreas Kleen, Portland, OR (US); Stephen Van Doren, Portland, OR (US); Omid Azizi, Redwood City, CA (US); Mahesh Madhav, Portland, OR (US); Mahesh Maddury, Santa Clara, CA (US); Chandan Egbert, San Jose, CA (US)

(21) Appl. No.: 15/941,468

(22) Filed: Mar. 30, 2018

(51) Int. Cl. G06F 12/02; G06F 12/06

(52) U.S. Cl. CPC G06F 12/0238; G06F 12/0684

(57) ABSTRACT

Various systems and methods for controlling memory traffic flow rate are described herein. A system for computer memory management, the system comprising: rate control circuitry to: receive a rate exceeded signal from monitoring circuitry, the rate exceeded signal indicating that memory traffic flow from a traffic source exceeds a threshold; receive a distress signal from a memory controller that interfaces with a memory device, the distress signal indicating that the memory device is oversubscribed; and implement throttle circuitry to throttle the memory traffic flow from the traffic source when the rate exceeded signal and the distress signal are both asserted.

### TECHNICAL FIELD

Embodiments described herein generally relate to computer memory management, and in particular to systems and methods for implementing survivability guarantees for memory traffic.

### BACKGROUND

Modern computing systems use an ever increasing amount of memory for operating systems, applications, and data. For efficient use of memory, various memory reduction techniques have been developed. Some memory reduction techniques aim to reduce the amount of memory used by using data compression techniques on the memory contents. Other memory reduction techniques eliminate duplicate copies of data in memory and use references to point to a single copy of the data, such as with memory deduplication techniques. In either case, more addressable memory space is advertised than the actual physical memory available.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating hardware and software architecture of a computer system, in which various interfaces between hardware components and software components are shown, according to an embodiment;

FIG. 2 is a block diagram illustrating a memory traffic control system, according to an embodiment:

FIGS. 3A and 3B are block diagrams illustrating a monitored system environment, according to an embodiment:

FIG. 4 is a schematic diagram illustrating a monitoring circuitry, according to an embodiment;

FIG. 5 is a schematic diagram illustrating a rate control circuitry, according to an embodiment;

FIG. 6 is a flowchart illustrating a method for controlling memory traffic flow rate, according to an embodiment;

FIG. 7 is a block diagram illustrating an example machine upon which any one or more of the techniques (e.g., methodologies) discussed herein may perform, according to an embodiment;

FIGS. 8A-8B are block diagrams illustrating a generic vector friendly instruction format and instruction templates thereof according to an embodiment;

FIGS. 9A-9D are block diagrams illustrating a specific vector friendly instruction format according to an embodiment;

FIG. 10 is a block diagram of a register architecture according to an embodiment:

FIG. 11A is a block diagram illustrating both an in-order pipeline and a register renaming, out-of-order issue/execution pipeline according to an embodiment;

FIG. 11B is a block diagram illustrating both an in-order architecture core and a register renaming, out-of-order issue/execution architecture core to be included in a processor according to an embodiment;

FIGS. 12A-12B illustrate block diagrams of a more specific in-order core architecture, which core would be one of several logic blocks (including other cores of the same type and/or different types) in a chip, according to an embodiment;

FIG. 13 is a block diagram of a processor that may have more than one core, may have an integrated memory controller, and may have integrated graphics according to an embodiment;

FIGS. 14-17 are block diagrams of computer architectures, according to an embodiment; and

FIG. 18 is a block diagram contrasting the use of a software instruction converter to convert binary instructions in a source instruction set to binary instructions in a target instruction set according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Use of memory reduction techniques allow a memory consumer (e.g., an application, an operating system, a process, etc.) to address more memory than is actually available at the physical level. In other words, memory address space is decoupled from memory data space. For instance, an 8 gigabyte (GB) memory device may be advertised as having 12 GB of storage space available. When applications allocate memory in the memory device, some of the applications' data is compressed so that from the applications' point-of-view, there is 12 GB of addressable space (e.g., address space) that indirect into 8 GB of physical memory space (e.g., data space).

In an example, a system may use a memory reduction technique referred to as deduplication. Memory deduplication is a process for efficient memory use. Instead of storing multiple copies of the same data, one deduplicated copy is stored and additional data structures are used to track which processes may use the same “deduplicated” data. Memory deduplication is performed in hardware and may be a part of the memory controller. By deduplicating data, a memory controller may advertise more address space than there is data space.

Another example of memory reduction is a system that uses compression technology to compress contents of the physical memory and hence use memory more efficiently. In such a system when the central processing unit (CPU) writes a block of memory, for example a 4 kilobyte (KB) page, actual physical memory consumption may be much less than 4 KB if the contents of the page are compressed, hence allowing the physical memory to accommodate more contents than the original size of the block that was written.

The difference between the address space (or addressable space) and the data space is determined by the amount of compression (e.g., compression ratio) the data undergoes. Based on various implementations, the compression ratio may be as high as 2:1, 2.5:1, or even higher, of address space to data space.

In such systems, the actual physical memory consumption may vary over time as data contents may have different compression ratios over the course of program execution. Decoupling of the address space from data space prevents system software from being aware of how much physical memory is actually consumed in the system. As a result, this indirection prevents system software from taking necessary actions in cases where physical memory is approaching its limit. Traditionally when the system software manages all physical memory, it is aware of the memory consumption and may start freeing space by swapping out to other forms of storage.

“Memory pressure” is a condition where physical memory consumption of the data space is approaching its limits (e.g., getting full) and the advertised address space is overcommitted. In such a situation, the system software may continue to attempt to allocate memory, its metrics erroneously indicating that there is underlying data space available, when in reality, the data space is at or near capacity. Attempts to write to a completely full physical memory space may result in data loss, memory errors, crashes, or other error states.

In an overcommitted memory system (e.g., a memory system with compression and/or deduplication), the amount of memory available for use by software varies with the content that is written into memory. In such a system, software may cause the system to run out of usable memory simply by overwriting the contents of already allocated memory pages with less compressible content. The operating system (OS) is expected to deal with this memory pressure by swapping out memory to disk.

However, since the degree to which memory contents are compacted is workload dependent, the actual compaction rate for a given workload may vary substantially and might overflow the available physical memory in worst case scenarios. In such cases, the incoming traffic may overrun available memory resources and cause data loss and system failure. Systems and methods described herein provide survivability guarantees by limiting the rate of the traffic coming to memory in order to prevent exhausting available memory resources and avoiding system failure.

A rate limiting mechanism to control the flow of traffic injected into the system, as described herein, provides an innovative approach to improve the operation of a computing system with overcommitted memory. The rate limiting architecture may be implemented in hardware and be accessible from a software stack, such as through drivers, OS libraries, or the like. The rate limiting architecture may be implemented in hardware and accessible from a software stack, such as through drivers. OS libraries, or the like. The rate limiting architecture described herein ensures the deduplicated memory region cannot overflow—guaranteeing physical memory resources. By slowing down the injected traffic, critical system resources are not exhausted and other system components are given enough time to propagate critical events, such as interrupts to processor cores.

Providing survivability guarantees is one of the fundamental requirements for all compute products. Such features are most prominent in server processors where multiple potentially critical applications share the same compute and memory resources. Introduction of new memory technologies into a server product line, such memory deduplication, significantly affects characteristics and behavior of servers' memory sub-system and introduces conditions, which if not handled properly, might compromise the performance or functionality of the platform. A prominent example is the memory oversubscription condition that may occur due to introduction of the memory deduplication feature.

When a system's memory resources are oversubscribed, care should be taken such that those resources are not overrun by the cores and applications, causing data loss and system failure. An example includes a system that applies compression or deduplication to memory in order to increase the effective capacity. In such a system, applications typically observe a larger memory than what actually exists in system hardware, relying on the fact that underlying compression or deduplication logic is able to compact data values in the existing hardware memory. However, since the degree of such compaction depends on the application's data content, there are certainly situations where available hardware memory resources might be overrun, leading to data loss and application failure.

Systems and methods described here provide rate limiting mechanisms to monitor the rate at which cores send out memory transactions. Based on the detection of the memory oversubscription condition, the rate limiting mechanisms limit the rate of such transaction injection so that the system has enough time to react. The hardware may provide alerts to system software, which may then perform remedial function.

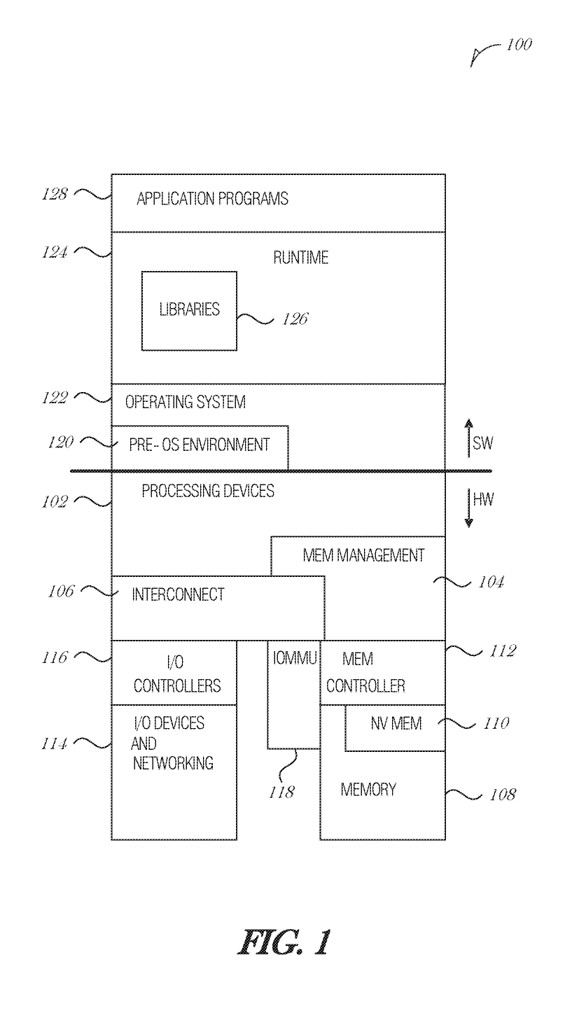

FIG. 1 is a diagram illustrating hardware and software architecture 100 of a computing system, in which various interfaces between hardware components and software components are shown, according to an embodiment. As indicated by HW, hardware components are represented below the divider line, whereas software components (denoted by SW) reside above the divider line. On the hardware side, processing devices 102 (which may include one or more microprocessors, digital signal processors, etc., each having one or more processor cores, are interfaced with memory management device 104 and system interconnect 106. Memory management device 104 provides mappings between virtual memory used by processes being executed, and the physical memory. Memory management device 104 may be an integral part of a central processing unit which also includes the processing devices 102.

Interconnect 106 includes a backplane such as memory, data, and control lines, as well as the interface with input/output devices, e.g., PCI, USB, etc. Memory 108 (e.g., dynamic random access memory—DRAM) and non-volatile memory 110 such as flash memory (e.g., electrically-erasable read-only memory—EEPROM, NAND Flash, NOR Flash, etc.) are interfaced with memory management device 104 and interconnect 106 via memory controller 112. This architecture microarchitecture 100 may support direct memory access (DMA) by peripherals in some embodiments. I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 114, which interface with interconnect 106 via corresponding I/O controllers 116.

In a related embodiment, input/output memory management unit IOMMU 118 supports secure direct memory access (DMA) by peripherals. IOMMU 118 may provide memory protection by meditating access to memory 108 from I/O device 114. IOMMU 118 may also provide DMA memory protection in virtualized environments, where it allows certain hardware resources to be assigned to certain guest VMs running on the system, and enforces isolation between other VMs and peripherals not assigned to them.

On the software side, a pre-operating system (pre-OS) environment 120, which is executed at initial system start-up and is responsible for initiating the boot-up of the operating system. One traditional example of pre-OS environment 120 is a system basic input/output system (BIOS). In present-day systems, a unified extensible firmware interface (UEFI) may be implemented. Pre-OS environment 120, is responsible for initiating the launching of the operating system, but also provides an execution environment for embedded applications.

Operating system (OS) 122 provides one or more kernels that control the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 122 provides device drivers, and a variety of common services such as those that facilitate interfacing with peripherals and networking, that provide abstraction for application programs so that the applications do not need to be responsible for handling the details of such common operations. Operating system 122 additionally provides a graphical user interface (GUI) that facilitates interaction with the user via peripheral devices such as a monitor, keyboard, mouse, microphone, video camera, touchscreen, and the like.

Runtime system 124 implements portions of an execution model, including such operations as putting parameters onto the stack before a function call, the behavior of disk input/output (I/O), and parallel execution-related behaviors. Runtime system 124 may also perform support services such as type checking, debugging, or code generation and optimization.

Libraries 126 include collections of program functions that provide further abstraction for application programs. These include shared libraries, dynamic linked libraries (DLLs), for example. Libraries 126 may be integral to the operating system 122, runtime system 124, or may be added-on features, or even remotely-hosted. Libraries 126 define an application program interface (API) through which a variety of function calls may be made by application programs 128 to invoke the services provided by the operating system 122. Application programs 128 are those programs that perform useful tasks for users, beyond the tasks performed by lower-level system programs that coordinate the basis operability of the computing device itself.

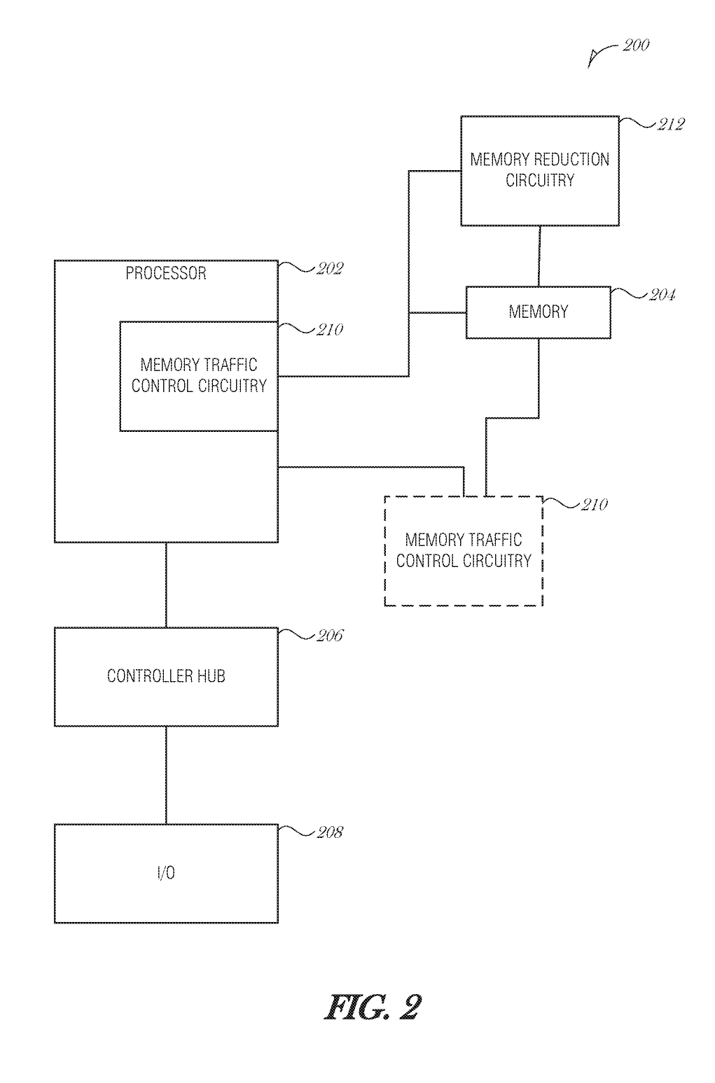

FIG. 2 is a block diagram illustrating a memory traffic control system 200, according to an embodiment. The memory traffic control system 200 includes a processor 202, a memory device 204, a controller hub 206, and input/output (I/O) devices 208. While only one processor 202 is illustrated in FIG. 2, it is understood that one or more processors 202 may be included in the system 200.

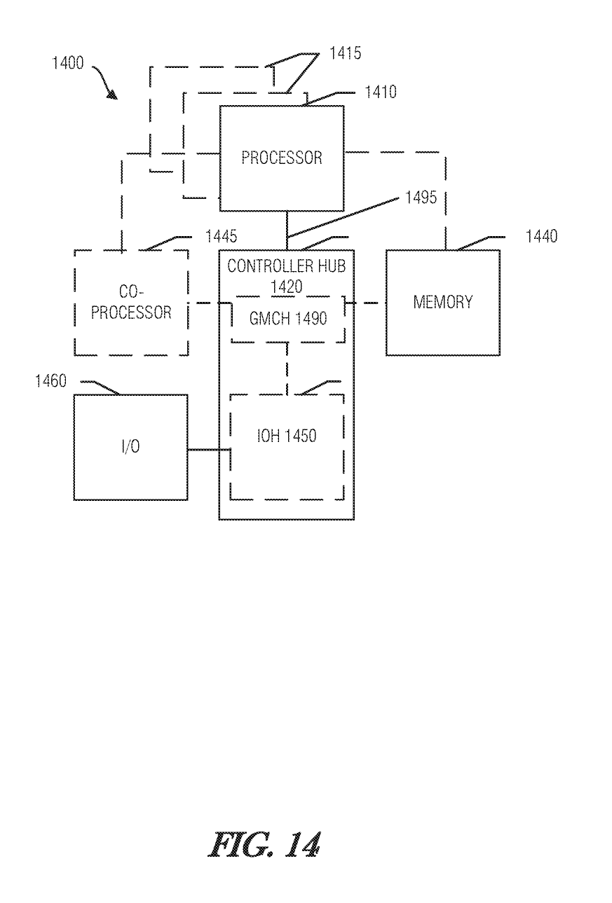

The processor 202 is coupled to the controller hub 206 to pass control signals and data to I/O devices 208. The controller hub 206 may include sub-controllers, such as a graphics memory controller hub (GMCH) or an I/O hub (IOH), which may be on separate chips. The controller hub 206 communicates with the processor 202 via a multi-drop bus, such as a frontside bus (FSB), point-to-point interface such as QuickPath Interconnect (QPI), or similar connection. In various embodiments, the controller hub 206 may be an instance of controller hub 1420 of FIG. 14.

The memory 204 is coupled directly to the processor 202. The memory 204 may be, for example, dynamic random access memory (DRAM), phase change memory (PCM), or a combination of the two.

A memory traffic control circuitry 210 is associated with the processor 202. Each processor 202 in a multi-processor system includes a corresponding memory traffic control circuitry 210. The memory traffic control circuitry 210 monitors the amount of memory traffic produced by the processor 202 to determine if the processor 202 is injecting more than a threshold amount of memory traffic to the memory device 204.

The system 200 also includes a memory reduction circuitry 212, which may be integrated into a memory controller in the processor 202, or may be a separate unit. For instance, the memory reduction circuitry 212 may be a coprocessor or other special-purpose processor. In various embodiments, the memory reduction circuitry 212 may be an instance of memory controller 20xx of FIG. 2xx.

Memory reduction circuitry 212 is used to compress/deduplicate data in the data region of the memory 204. To service an address request received from a requester, for example processor 202, the memory reduction circuitry 212 references a mapping table to indirect into the data region of the memory device 204. The memory reduction circuitry 212 manages all accesses to the memory 204. This hardware intercepts all traffic, and implements the logic to (1) determine where the data for an address resides, and (2) store and free data in the data region in memory 204 as necessary.

The mapping table includes mappings from address space to data space, or in other words, from logical address space to physical data space. In an embodiment, the mapping table is a table of pointers that map system addresses from the processor 202 to the location of the compressed or deduplicated data on the physical memory device 204. In the simplest embodiment, the mapping table maps fixed-size chunks of the address space into compressed or deduplicated chunks in the data region on the memory device 204.

The memory reduction circuitry 212 may be configured to detect and raise an alert when a memory oversubscription condition occurs or is likely to occur. Memory oversubscription is when memory hardware resources are overrun with requests in a deduplicated or compressed architecture such that the physical memory 204 may not be able to handle all of the requests. When memory oversubscription occurs, the memory reduction circuitry 212 may transmit a distress signal, which is propagated to the memory traffic control circuitry 210.

When the memory traffic control circuitry 210 receives a distress signal from the memory reduction circuitry 212, the memory traffic control circuitry 210 may throttle the input traffic of the processor 202 to ease memory requests at the memory reduction circuitry 212 and reduce the rate at which memory is consumed. The memory traffic control circuitry 210 may include rate control circuitry to perform the rate control of input traffic. The memory traffic control circuitry 210 may be configured so that outbound traffic (e.g., traffic returning to the processor 202 from the memory 204) is not throttled. This allows for pending memory requests to be serviced. By limiting input traffic, the system illustrated in FIG. 2 improves the function of the machine to allow for a graceful recovery and avoid catastrophic memory-related failures.

The memory traffic control circuitry 210 may be integrated into a memory controller in the processor 202, or may be a separate unit. For instance, the memory traffic control circuitry 210 may be a coprocessor or other special-purpose processor.

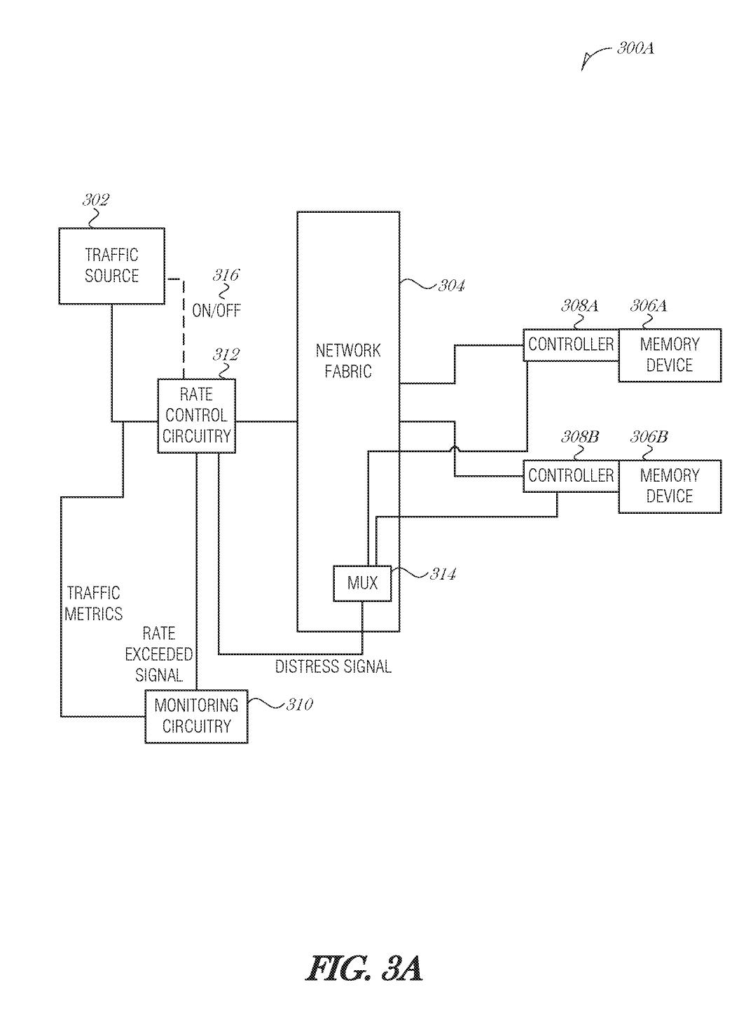

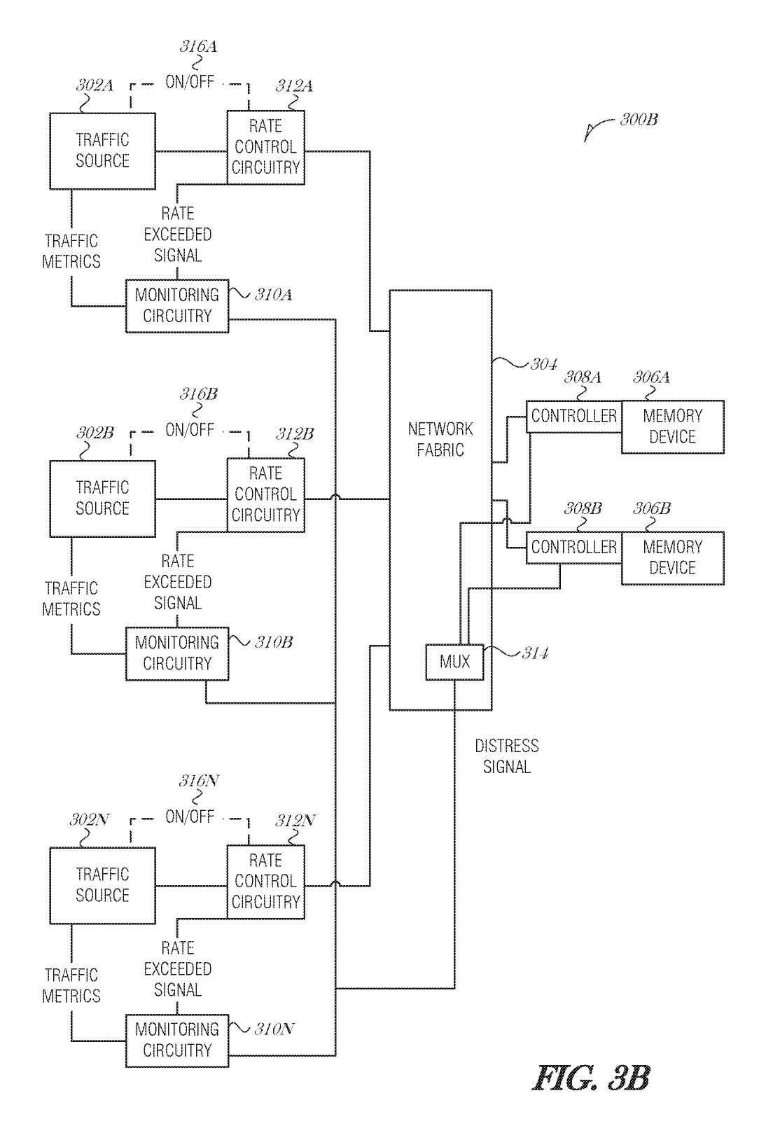

FIG. 3A is a block diagram illustrating a monitored system environment 300A, according to an embodiment. A traffic source 302 is connected to a network fabric 304. Memory devices 306A and 306B are connected to the network fabric 304 via respective controllers 308A and 308B. The traffic source 302 may be a processor or other compute unit that uses the memory devices 306A-B. The memory devices 306A-B may be, for example, dynamic random access memory (DRAM), phase change memory (PCM), or a combination of the two. The controllers 308A-B (e.g., memory controller 1314 of FIG. 13) communicate with the traffic source 302 (e.g., processor 1300 of FIG. 13) via the network fabric 304. The network fabric 304 may include a multi-drop bus, such as a frontside bus (FSB), point-to-point interface such as QuickPath Interconnect (QPI), or similar connection.

Monitoring circuitry 310 monitors the traffic source 302 and the requests that are injected into the network fabric 304 by the traffic source 302. The monitoring circuitry 310 may implement a leaky-bucket algorithm to determine if the traffic source 302 exceeds a predefined traffic injection rate. Other types of thresholding, traffic policing, or rate monitoring may be used.

The monitoring circuitry 310 may be part of or integrated to operate with memory controllers or other interfaces, such as memory management device 104 or memory controller 112 of FIG. 1. Alternatively, monitoring circuitry 310 may be part of or integrated to operate with processor 1300 or memory controller unit 1314 of FIG. 13, for example. The monitoring circuitry 310 may be a controller that is separate from existing memory control devices. In general, the monitoring circuitry 310 may be located anywhere between the processor cores and the memory device 306. While the monitoring circuitry 310 may be incorporated into a memory controller, it may also be a separate circuit on-die with the cores, or off-die from the cores as a separate ASIC, FPGA, or other circuitry.

Controllers 308A-B provide the signaling to the monitoring circuitry 310 through the fabric 304. The purpose of the signaling mechanism is to communicate critical system conditions back to traffic sources fast enough to prevent the system from failing. For this purpose, the signaling mechanism uses dedicated distress signals routed along with other fabric signals that carry regular traffic. The distress signal is monitored by all the entities on the fabric that inject traffic which need to react upon receiving the notification, including the monitoring circuitry 310. It is driven by the entities managing critical system resources that may detect undesirable or potentially critical system conditions, such as resource oversubscription. If there are multiple such resource managers, their signals may be combined to notify all traffic sources uniformly. The distress signal may be level-triggered, edge-triggered, a pulse or any other suitable mechanism. The exact nature of the distress signal depends on the system architecture, nature of the distress condition, or type of interfaces of its senders or receivers.

In a system that uses compression or deduplication to oversubscribe the existing hardware memory, the distress signal is generated by the compression or deduplication engine which have information about the exact utilization of the available hardware memory. In the embodiment illustrated in FIG. 3, the controllers 308A-B trigger the distress signal when appropriate. When the utilization reaches a critical level, the controller 308A-B generates a distress signal to the traffic source (e.g., core), to slow down the rate at which memory is written. This in turn allows more time for the system software to be notified, and to react by taking necessary steps to reduce memory consumption through software means, such as writing pages to the backing store.

The controllers 308A-B maintain memory consumption levels of the respective memory devices 306A-B. When memory consumption reaches a predefined level, then the controller 308A-B triggers an interrupt to reduce the memory requests from the traffic source 302.

The controller 308A-B may use configurable interrupts that are triggered whenever memory consumption reaches certain predefined levels. An interrupt may cause a distress signal to be transmitted to the monitoring circuitry 310. This allows the traffic source 302 to quiesce and reduce writes to memory, thereby releasing some memory pressure and preventing generation of more memory traffic that could potentially exhaust physical memory. Information relevant to the level of memory consumption may be provided to software as registers (or machine check banks).

When the distress signal is activated, the rate control circuitry 312 is used to throttle memory accesses into the network fabric 304. The rate control circuitry 312 receives a signal from the monitoring circuitry 310 and a distress signal from the multiplexer 314 (MUX). The multiplexer 314 may be one or more logical OR gates that takes signals from the controllers 308A-B and outputs the distress signal. If the distress signal from any of the controllers 308A-B is high, then the output is high, indicating that at least one of the memory devices 306A-B is oversubscribed. If the monitoring circuitry 310 determines that the traffic source 302 is exceeding its predefined request rate, and the distress signal is activated, then the rate control circuitry 312 is activated to throttle the input rate. For example, the rate control circuitry 312 may allow the traffic source 302 to send a request on the network fabric 304 every ten cycles. This rate may be a fixed, a configurable, or a variable value which is adjusted either at start up time or during run time.

A variable control rate may be implemented in various ways. In an embodiment, the variable rate is programmed by software to change the rate's value based on factors. For example, based on number of active processor cores in the system, the variable rate may be set higher or lower. For instance, a system with fewer active cores may have a higher rate than a system with more active cores.

The rate control circuitry 312 does not throttle the traffic that flows from network fabric 304 to the traffic source 302, because such traffic may include replies that come back to a requestor, or requests from other system components that need to be processed by the requestor.

Optionally, the rate control circuitry 312 may implement an on/off switch 316 that allows an external entity (e.g. a processor core) to turn the rate control circuitry 312 off in certain situations. For example, if a throttled core starts running a privileged thread (i.e., system software) that is not using the oversubscribed memory resources, the core may disable the rate control circuitry 312 to turn the throttling mechanism off and allow the system software full access to the network fabric 304.

FIG. 3B is another block diagram illustrating a monitored system environment 300B, according to an embodiment. The illustrated components operate in manner consistent with the components described above with respect to FIG. 3A. However, as illustrated in FIG. 3B, multiple traffic sources 302A-N are connected to the distress signal from the multiplexer 314. Thus, while the multiplexer 314 still aggregates the distress signals from the various controllers 308A-B, the output is consumed by multiple traffic sources 302A-N via the respective monitoring circuitries 310A-N, which operate in the same way that monitoring circuitry 310 of FIG. 3A does. Thus, when one or more controllers 308A-B activate the distress signal, the multiplexer 314 propagates the distress signal to all traffic sources 302A-N on the bus. Each rate control circuitry 312A-N then evaluates whether the rate exceeded signal is active, and if so, throttles the corresponding traffic source 302A-N.

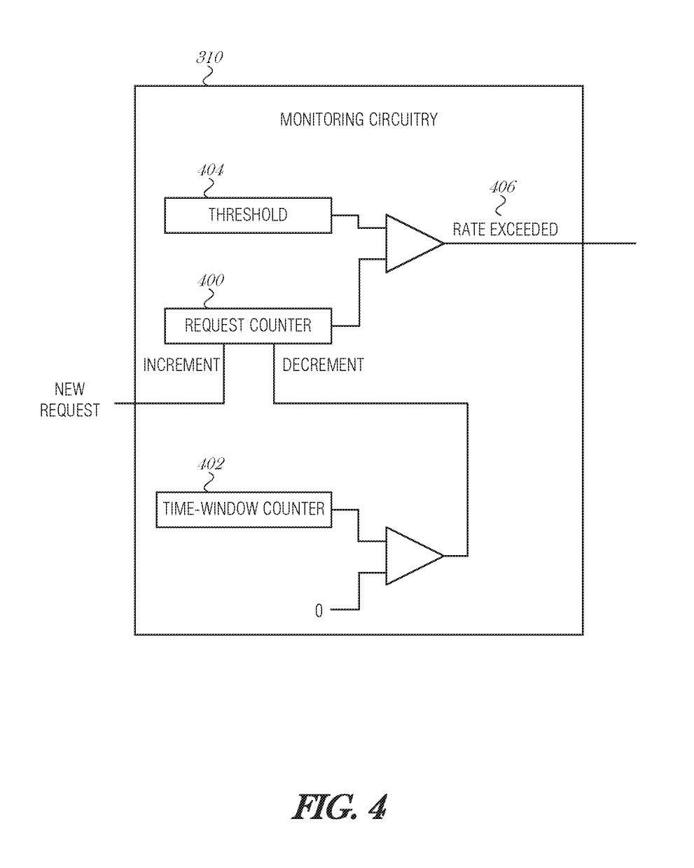

FIG. 4 is a schematic diagram illustrating a monitoring circuitry 310, according to an embodiment. In an embodiment, the monitoring circuitry 310 uses a leaky-bucket mechanism to determine whether the traffic source 302 is generating more traffic than a threshold rate. The monitoring circuitry 310 includes a request counter 400, a time-window counter 402, and a threshold value 404.

The time-window counter 402 is programmed with a predefined time value and is decremented every clock cycle. When the time-window counter 402 reaches zero, it is reloaded with the predefined value and starts to count down again. The predefined value may be provided at the time of manufacture, or may be programmed by a system implementer or end user, in various embodiments. The predefined value may be on the order of a few milliseconds to seconds.

The request counter 400 counts the number of requests that are issued by the traffic source 302 to the network fabric 304. Whenever a request is injected into the network fabric 304, the request counter 400 is incremented. Whenever the time-window elapses (i.e., time-window counter 402 reaches zero), the request counter 400 is decremented. As a result, the request counter 400 keeps a history of how fast the traffic source 302 is injecting requests into the fabric 304. Therefore, comparing the request counter 400 with the predefined threshold value 404 indicates whether the traffic source 302 is exceeding a given injection rate (e.g., requests per time-window counter period). The output rate exceeded signal 406 indicates whether the injection rate is higher than the threshold value 404. The rate exceeded signal 406 is used by a rate control circuitry 312 to enable the throttling mechanism, such as when a critical system condition (such as memory pressure) is reported by a signaling system.

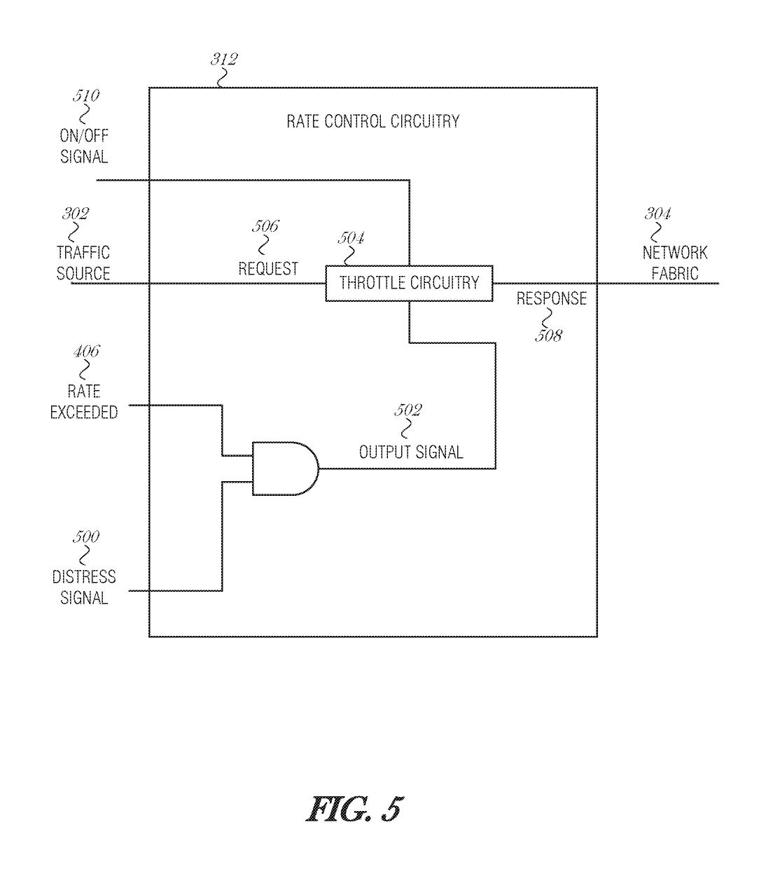

FIG. 5 is a schematic diagram illustrating a rate control circuitry 312, according to an embodiment. The rate control circuitry 312 receives the rate exceeded signal 406 from the monitoring circuitry 310, and the distress signal 500 from the multiplexer 314. The rate exceeded signal 406 and distress signal 500 are input into an AND gate, producing an output signal 502. If the output signal 502 is high, then throttle circuitry 504 is engaged to reduce the memory requests over time. The throttle circuitry 504 receives requests 506 from a traffic source 302 and passes them through to the network fabric 304. The throttle circuitry 504 may also receive responses 508 from the network fabric 304 that may be destined for the traffic source 302. In another embodiment, response traffic is routed around the rate control circuitry 312 and the throttle circuitry 504.

The throttle circuitry 504 may include various buffers, control circuitry, and other structures to buffer requests 506 and then forward them at a reduced rate, transmit a control signal to the traffic source to quiesce, or handle an express control signal from the traffic source 302. The express control signal may be an override signal that enables or disables the throttle circuitry 504 regardless of the state of the rate exceeded signal 406 or the distress signal 500. In an embodiment, the express control signal includes the on/off signal 510 to control the operation of the throttle circuitry 504.

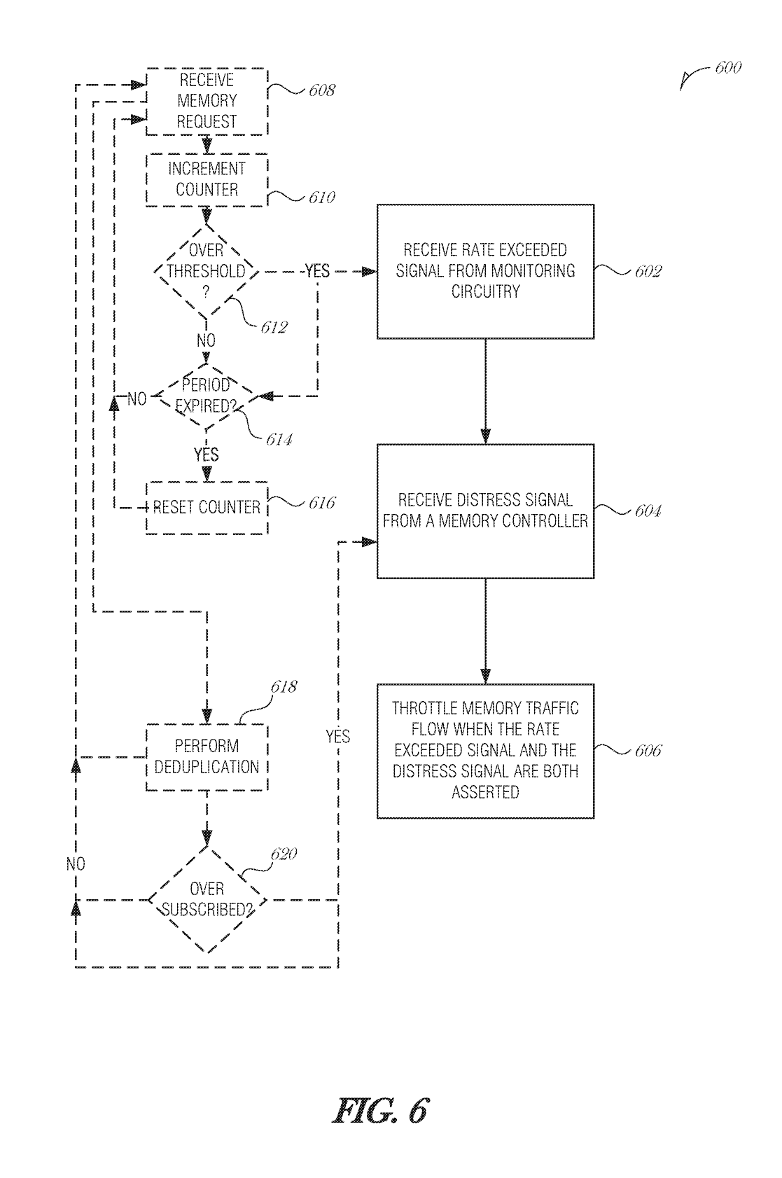

FIG. 6 is a flowchart illustrating a method 600 for controlling memory traffic flow rate, according to an embodiment. The operations of the method 600 are implemented in hardware, such as circuitry, processors, etc.

At operation 602, a rate exceeded signal is received. Here, the rate exceeded signal indicates that memory traffic flow from a traffic source exceeds a threshold. In an example, the method 600 may be extended to include using a leaky-bucket algorithm to determine whether to assert the rate exceeded signal.

At operation 604, a distress signal from a memory controller that interfaces with a memory device is received. Here, the distress signal indicates that the memory device is oversubscribed. In an example, the memory controller that interfaces with the memory device implements memory deduplication. Thus, in an example, when the memory request is received at optional operation 608, deduplication of the memory may be performed at optional operation 618. If the physical memory is now oversubscribed (optional decision 620), then the distress signal may be generated.

At operation 606, the memory traffic flow from the traffic source is throttled when the rate exceeded signal and the distress signal are both asserted. In an example, throttling the memory traffic flow from the traffic source includes using a fixed throttle rate. In an example, throttling the memory traffic flow from the traffic source includes using a variable throttle rate. In an example, the variable throttle rate is a function of a number of active cores in a system.

The method 600 may be extended to include receiving a control signal to enable or disable the throttling regardless of whether the rate exceeded signal or the distress signal are asserted. The method 600 may be extended to include not throttling response traffic to the traffic source.

Rate may be determined via a counter. Thus, at optional operation 608, a memory request is received. At operation optional 610, the counter is incremented. At optional decision 612, if the counter is over a threshold, then the rate exceeded signal may be produced. Otherwise, at optional decision 614, if the time-period has expired, the counter is reset (optional operation 616). Accordingly, the method 600 may be extended to include maintaining a request counter. Here, the request counter tracks how many requests are received in a time period. In an example, the time period is a number of clock cycles. In an example, the time period is measured using a time-window counter. In an example, the time-window counter is configured to count down from a predetermined value at each clock cycle and cause the request counter to reset.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

As used in any embodiment herein, the term “logic” may refer to firmware and/or circuitry configured to perform any of the aforementioned operations. Firmware may be embodied as code, instructions or instruction sets and/or data that are hard-coded (e.g., nonvolatile) in memory devices and/or circuitry.

“Circuitry.” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry executing code and/or instructions sets (e.g., software, firmware, etc.) corresponding to the functionality described herein, thus transforming a general-purpose processor into a specific-purpose processing environment to perform one or more of the operations described herein. In some embodiments, the processor circuitry may be embodied as a stand-alone integrated circuit or may be incorporated as one of several components on an integrated circuit. In some embodiments, the various components and circuitry of the node or other systems may be combined in a system-on-a-chip (SoC) architecture.

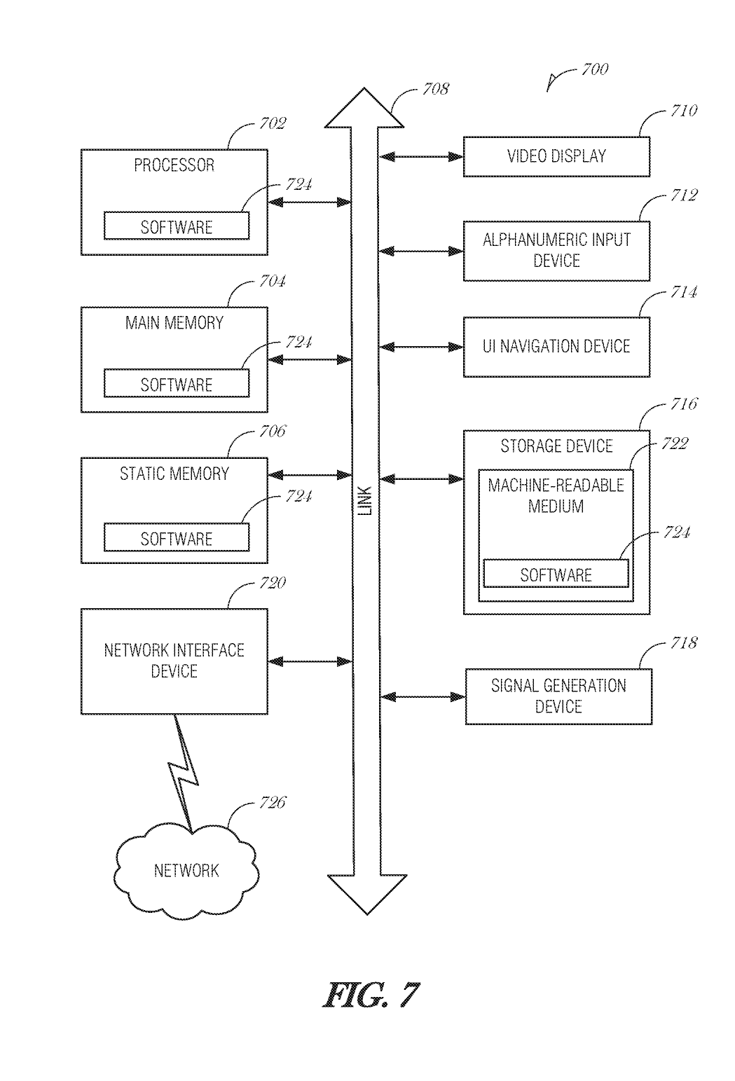

FIG. 7 is a block diagram illustrating a machine in the example form of a computer system 700, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus). The computer system 700 may further include a video display unit 710, an alphanumeric input device 712 (e.g., a keyboard), and a user interface (UI) navigation device 714 (e.g., a mouse). In one embodiment, the video display unit 710, input device 712 and UI navigation device 714 are incorporated into a touch screen display. The computer system 700 may additionally include a storage device 716 (e.g., a drive unit), a signal generation device 718 (e.g., a speaker), a network interface device 720, and one or more sensors (not shown), such as a global positioning system (GPS) sensor, compass, accelerometer, gyrometer, magnetometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the computer system 700, with the main memory 704, static memory 706, and the processor 702 also constituting machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, Wi-Fi, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

The figures below detail architectures and systems to implement embodiments of the above. In some embodiments, one or more hardware components and/or instructions described above are emulated as detailed below, or implemented as software modules.

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, systems, architectures, and pipelines are detailed below. Embodiments of the instruction(s) above may be executed on such systems, architectures, and pipelines, but are not limited to those detailed.

An instruction set may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down though the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. A set of SIMD extensions referred to as the Advanced Vector Extensions (AVX) (AVX1 and AVX2) and using the Vector Extensions (VEX) coding scheme has been released and/or published (e.g., see Intel® 64 and IA-32 Architectures Software Developer's Manual, September 2014; and see Intel® Advanced Vector Extensions Programming Reference, October 2014).

### Instruction Formats

Embodiments of the instruction(s) described herein may be embodied in different formats. Additionally, systems, architectures, and pipelines are detailed below. Embodiments of the instruction(s) may be executed on such systems, architectures, and pipelines, but are not limited to those detailed.

### Generic Vector Friendly Instruction Format

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

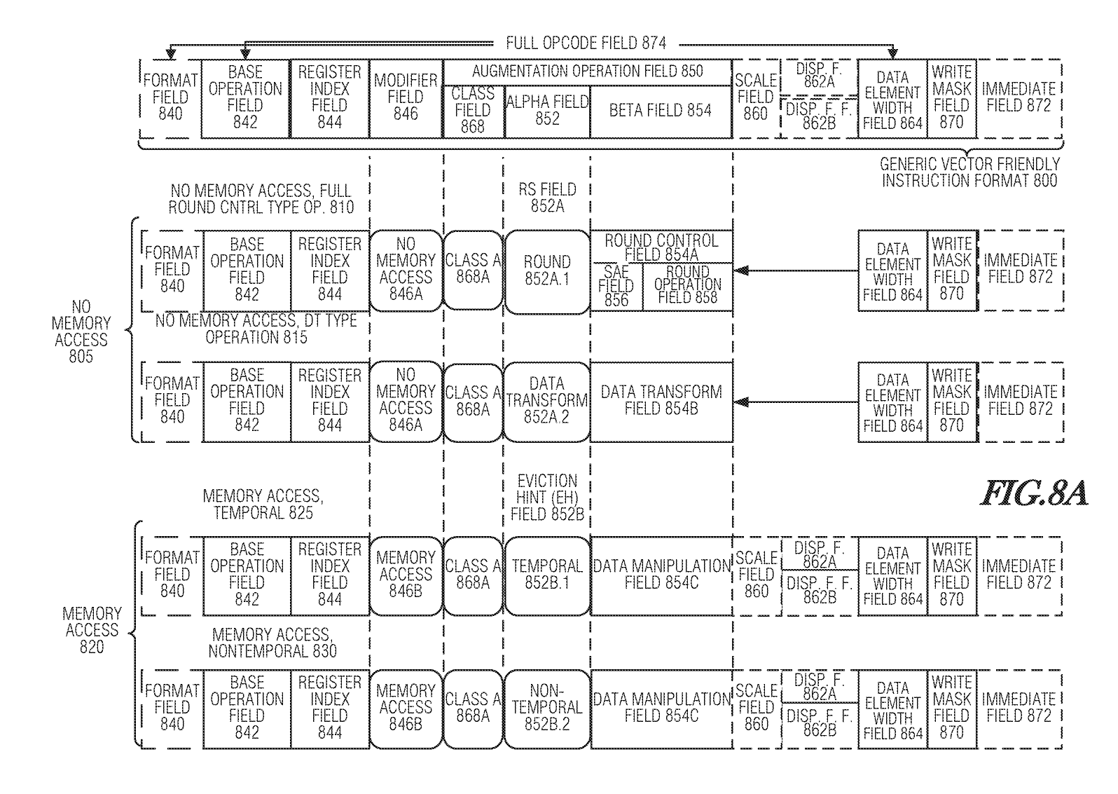

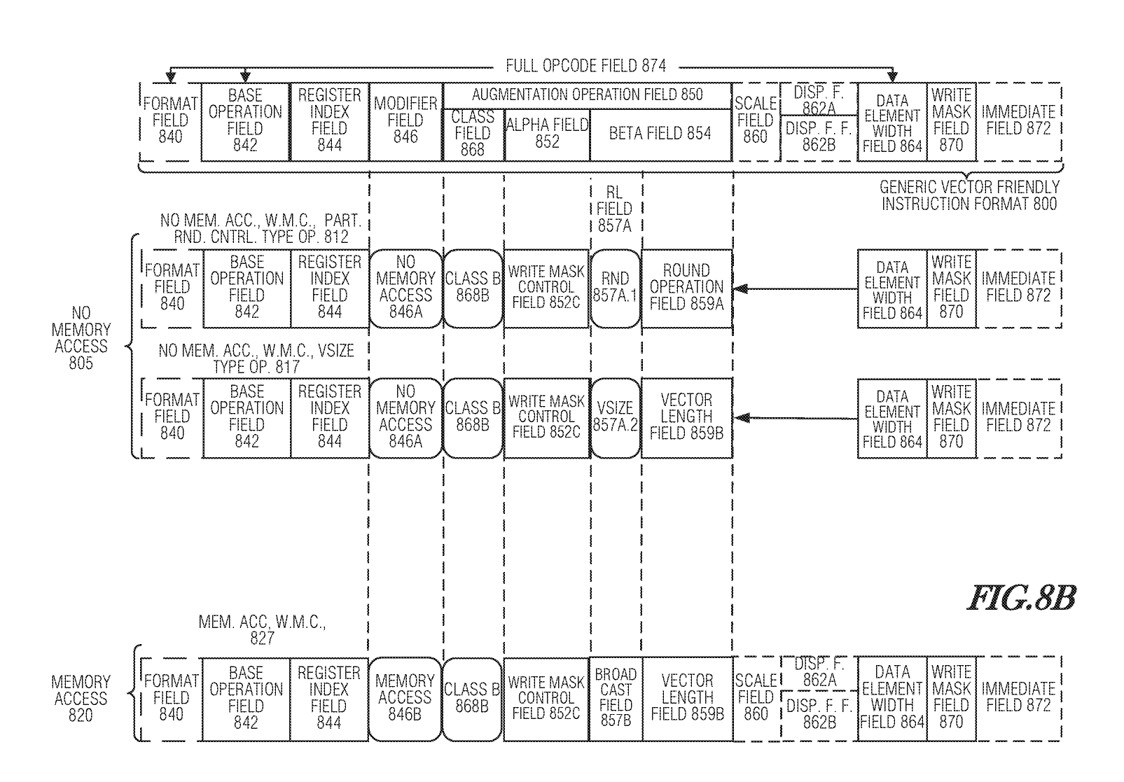

FIGS. 8A-8B are block diagrams illustrating a generic vector friendly instruction format and instruction templates thereof according to an embodiment. FIG. 8A is a block diagram illustrating a generic vector friendly instruction format and class A instruction templates thereof according to an embodiment; while FIG. 8B is a block diagram illustrating the generic vector friendly instruction format and class B instruction templates thereof according to an embodiment. Specifically, a generic vector friendly instruction format 800 for which are defined class A and class B instruction templates, both of which include no memory access 805 instruction templates and memory access 820 instruction templates. The term generic in the context of the vector friendly instruction format refers to the instruction format not being tied to any specific instruction set.

While embodiments will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes): and a 16 byte vector operand length (or size) with 32 bit (4 byte), 64 bit (8 byte), 16 bit (2 byte), or 8 bit (1 byte) data element widths (or sizes): alternative embodiments may support more, less and/or different vector operand sizes (e.g., 256 byte vector operands) with more, less, or different data element widths (e.g., 128 bit (16 byte) data element widths).

The class A instruction templates in FIG. 8A include: 1) within the no memory access 805 instruction templates there is shown a no memory access, full round control type operation 810 instruction template and a no memory access, data transform type operation 815 instruction template; and 2) within the memory access 820 instruction templates there is shown a memory access, temporal 825 instruction template and a memory access, non-temporal 830 instruction template. The class B instruction templates in FIG. 8B include: 1) within the no memory access 805 instruction templates there is shown a no memory access, write mask control, partial round control type operation 812 instruction template and a no memory access, write mask control vsize type operation 817 instruction template; and 2) within the memory access 820 instruction templates there is shown a memory access, write mask control 827 instruction template.

The generic vector friendly instruction format 800 includes the following fields listed below in the order illustrated in FIGS. 8A-8B.

Format field 840—a specific value (an instruction format identifier value) in this field uniquely identifies the vector friendly instruction format, and thus occurrences of instructions in the vector friendly instruction format in instruction streams. As such, this field is optional in the sense that it is not needed for an instruction set that has only the generic vector friendly instruction format.

Base operation field 842—its content distinguishes different base operations.

Register index field 844—its content, directly or through address generation, specifies the locations of the source and destination operands, be they in registers or in memory. These include a sufficient number of bits to select N registers from a PxQ (e.g., 32×512, 16×128, 32×1024, 64×1024) register file. While in an embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination).

Modifier field 846—its content distinguishes occurrences of instructions in the generic vector instruction format that specify memory access from those that do not; that is, between no memory access 805 instruction templates and memory access 820 instruction templates. Memory access operations read and/or write to the memory hierarchy (in some cases specifying the source and/or destination addresses using values in registers), while non-memory access operations do not (e.g., the source and destinations are registers). While in an embodiment this field also selects between three different ways to perform memory address calculations, alternative embodiments may support more, less, or different ways to perform memory address calculations. Augmentation operation field 850—its content distinguishes which one of a variety of different operations to be performed in addition to the base operation. This field is context specific. In an embodiment, this field is divided into a class field 868, an alpha field 852, and a beta field 854. The augmentation operation field 850 allows common groups of operations to be performed in a single instruction rather than 2, 3, or 4 instructions.

Scale field 860—its content allows for the scaling of the index field's content for memory address generation (e.g., for address generation that uses 2scale*index+base).

Displacement Field 862A—its content is used as part of memory address generation (e.g., for address generation that uses 2scale*index+base+displacement).

Displacement Factor Field 862B (note that the juxtaposition of displacement field 862A directly over displacement factor field 862B indicates one or the other is used)—its content is used as part of address generation; it specifies a displacement factor that is to be scaled by the size of a memory access (N)—where N is the number of bytes in the memory access (e.g., for address generation that uses 2scale*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 874 (described later herein) and the data manipulation field 854C. The displacement field 862A and the displacement factor field 862B are optional in the sense that they are not used for the no memory access 805 instruction templates and/or different embodiments may implement only one or none of the two.

Data element width field 864—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 870—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in another embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in an embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 870 allows for partial vector operations, including loads, stores, arithmetic, logical, etc. While embodiments are described in which the write mask field's 870 content selects one of a number of write mask registers that contains the write mask to be used (and thus the write mask field's 870 content indirectly identifies that masking to be performed), alternative embodiments instead or additional allow the mask write field's 870 content to directly specify the masking to be performed.

Immediate field 872—its content allows for the specification of an immediate. This field is optional in the sense that is it not present in an implementation of the generic vector friendly format that does not support immediate and it is not present in instructions that do not use an immediate.

Class field 868—its content distinguishes between different classes of instructions. With reference to FIGS. 8A-8B, the contents of this field select between class A and class B instructions. In FIGS. 8A-8B, rounded corner squares are used to indicate a specific value is present in a field (e.g., class A 868A and class B 868B for the class field 868 respectively in FIGS. 8A-8B).

### Instruction Templates of Class A

In the case of the non-memory access 805 instruction templates of class A, the alpha field 852 is interpreted as an RS field 852A, whose content distinguishes which one of the different augmentation operation types are to be performed (e.g., round 852A. 1 and data transform 852A.2 are respectively specified for the no memory access, round type operation 810 and the no memory access, data transform type operation 815 instruction templates), while the beta field 854 distinguishes which of the operations of the specified type is to be performed. In the no memory access 805 instruction templates, the scale field 860, the displacement field 862A, and the displacement scale filed 862B are not present.

### No-Memory Access Instruction Templates—Full Round Control Type Operation

In the no memory access full round control type operation 810 instruction template, the beta field 854 is interpreted as a round control field 854A, whose content(s) provide static rounding. While in the described embodiments the round control field 854A includes a suppress all floating point exceptions (SAE) field 856 and a round operation control field 858, alternative embodiments may support may encode both these concepts into the same field or only have one or the other of these concepts/fields (e.g., may have only the round operation control field 858).

SAE field 856—its content distinguishes whether or not to disable the exception event reporting: when the SAE field's 856 content indicates suppression is enabled, a given instruction does not report any kind of floating-point exception flag and does not raise any floating point exception handler.

Round operation control field 858—its content distinguishes which one of a group of rounding operations to perform (e.g., Round-up, Round-down, Round-towards-zero and Round-to-nearest). Thus, the round operation control field 858 allows for the changing of the rounding mode on a per instruction basis. In an embodiment where a processor includes a control register for specifying rounding modes, the round operation control field's 850 content overrides that register value.

### No Memory Access Instruction Templates—Data Transform Type Operation

In the no memory access data transform type operation 815 instruction template, the beta field 854 is interpreted as a data transform field 854B, whose content distinguishes which one of a number of data transforms is to be performed (e.g., no data transform, swizzle, broadcast).

In the case of a memory access 820 instruction template of class A, the alpha field 852 is interpreted as an eviction hint field 852B, whose content distinguishes which one of the eviction hints is to be used (in FIG. 8A, temporal 852B.1 and non-temporal 852B.2 are respectively specified for the memory access, temporal 825 instruction template and the memory access, non-temporal 830 instruction template), while the beta field 854 is interpreted as a data manipulation field 854C, whose content distinguishes which one of a number of data manipulation operations (also known as primitives) is to be performed (e.g., no manipulation; broadcast; up conversion of a source; and down conversion of a destination). The memory access 820 instruction templates include the scale field 860, and optionally the displacement field 862A or the displacement scale field 862B.

Vector memory instructions perform vector loads from and vector stores to memory, with conversion support. As with regular vector instructions, vector memory instructions transfer data from/to memory in a data element-wise fashion, with the elements that are actually transferred is dictated by the contents of the vector mask that is selected as the write mask.

### Memory Access Instruction Templates—Temporal

Temporal data is data likely to be reused soon enough to benefit from caching. This is, however, a hint, and different processors may implement it in different ways, including ignoring the hint entirely.

### Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

### Instruction Templates of Class B

In the case of the instruction templates of class B, the alpha field 852 is interpreted as a write mask control (Z) field 852C, whose content distinguishes whether the write masking controlled by the write mask field 870 should be a merging or a zeroing.

In the case of the non-memory access 805 instruction templates of class B, part of the beta field 854 is interpreted as an RL field 857A, whose content distinguishes which one of the different augmentation operation types are to be performed (e.g., round 857A.1 and vector length (VSIZE) 857A.2 are respectively specified for the no memory access, write mask control, partial round control type operation 812 instruction template and the no memory access, write mask control, VSIZE type operation 817 instruction template), while the rest of the beta field 854 distinguishes which of the operations of the specified type is to be performed. In the no memory access 805 instruction templates, the scale field 860, the displacement field 862A, and the displacement scale filed 862B are not present.

In the no memory access, write mask control, partial round control type operation 810 instruction template, the rest of the beta field 854 is interpreted as a round operation field 859A and exception event reporting is disabled (a given instruction does not report any kind of floating-point exception flag and does not raise any floating point exception handler).

Round operation control field 859A—just as round operation control field 858, its content distinguishes which one of a group of rounding operations to perform (e.g., Round-up, Round-down, Round-towards-zero and Round-to-nearest). Thus, the round operation control field 859A allows for the changing of the rounding mode on a per instruction basis. In an embodiment where a processor includes a control register for specifying rounding modes, the round operation control field's 850 content overrides that register value.

In the no memory access, write mask control VSIZE type operation 817 instruction template, the rest of the beta field 854 is interpreted as a vector length field 859B, whose content distinguishes which one of a number of data vector lengths is to be performed on (e.g., 128, 256, or 512 byte).

In the case of a memory access 820 instruction template of class B, part of the beta field 854 is interpreted as a broadcast field 857B, whose content distinguishes whether or not the broadcast type data manipulation operation is to be performed, while the rest of the beta field 854 is interpreted the vector length field 859B. The memory access 820 instruction templates include the scale field 860, and optionally the displacement field 862A or the displacement scale field 862B.

With regard to the generic vector friendly instruction format 800, a full opcode field 874 is shown including the format field 840, the base operation field 842, and the data element width field 864. While one embodiment is shown where the full opcode field 874 includes all of these fields, the full opcode field 874 includes less than all of these fields in embodiments that do not support all of them. The full opcode field 874 provides the operation code (opcode).

The augmentation operation field 850, the data element width field 864, and the write mask field 870 allow these features to be specified on a per instruction basis in the generic vector friendly instruction format.

The combination of write mask field and data element width field create typed instructions in that they allow the mask to be applied based on different data element widths.

The various instruction templates found within class A and class B are beneficial in different situations. In some embodiments, different processors or different cores within a processor may support only class A, only class B, or both classes. For instance, a high performance general purpose out-of-order core intended for general-purpose computing may support only class B, a core intended primarily for graphics and/or scientific (throughput) computing may support only class A, and a core intended for both may support both (of course, a core that has some mix of templates and instructions from both classes but not all templates and instructions from both classes is within the purview of the invention). Also, a single processor may include multiple cores, all of which support the same class or in which different cores support different class. For instance, in a processor with separate graphics and general purpose cores, one of the graphics cores intended primarily for graphics and/or scientific computing may support only class A, while one or more of the general purpose cores may be high performance general purpose cores with out of order execution and register renaming intended for general-purpose computing that support only class B. Another processor that does not have a separate graphics core, may include one more general purpose in-order or out-of-order cores that support both class A and class B. Of course, features from one class may also be implement in the other class in different embodiments. Programs written in a high level language would be put (e.g., just in time compiled or statically compiled) into an variety of different executable forms, including: 1) a form having only instructions of the class(es) supported by the target processor for execution; or 2) a form having alternative routines written using different combinations of the instructions of all classes and having control flow code that selects the routines to execute based on the instructions supported by the processor which is currently executing the code.

### Specific Vector Friendly Instruction Format

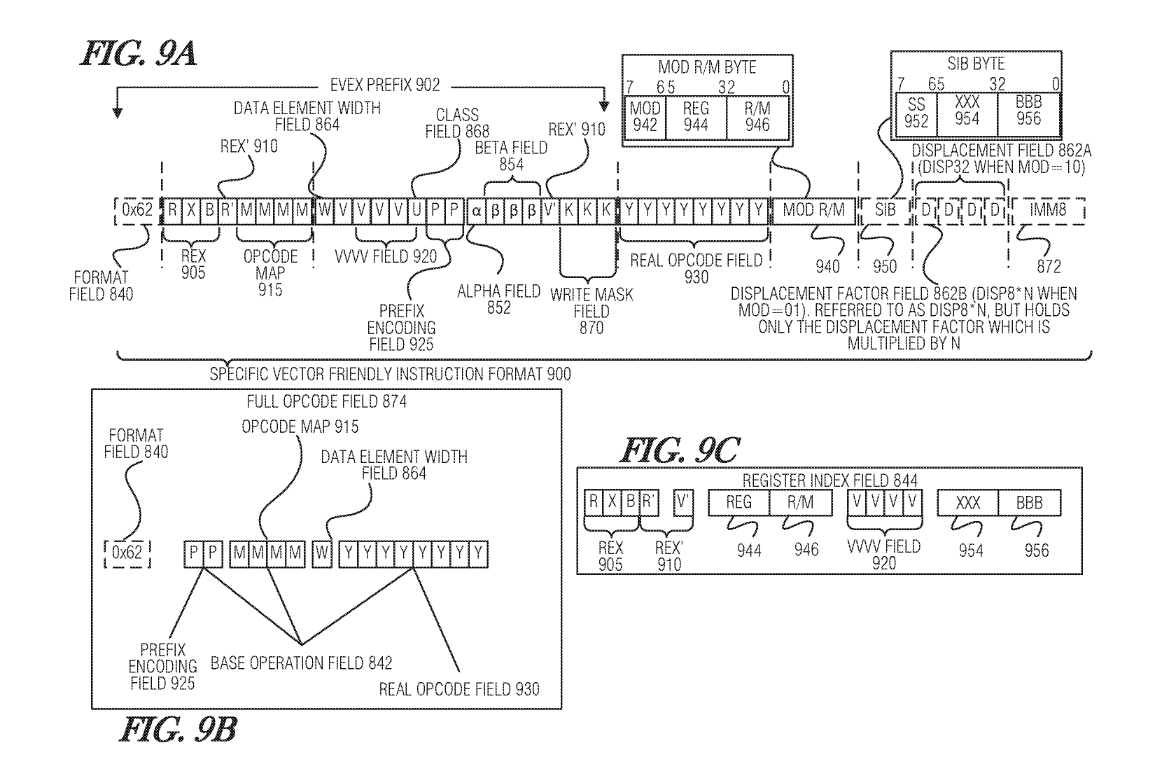

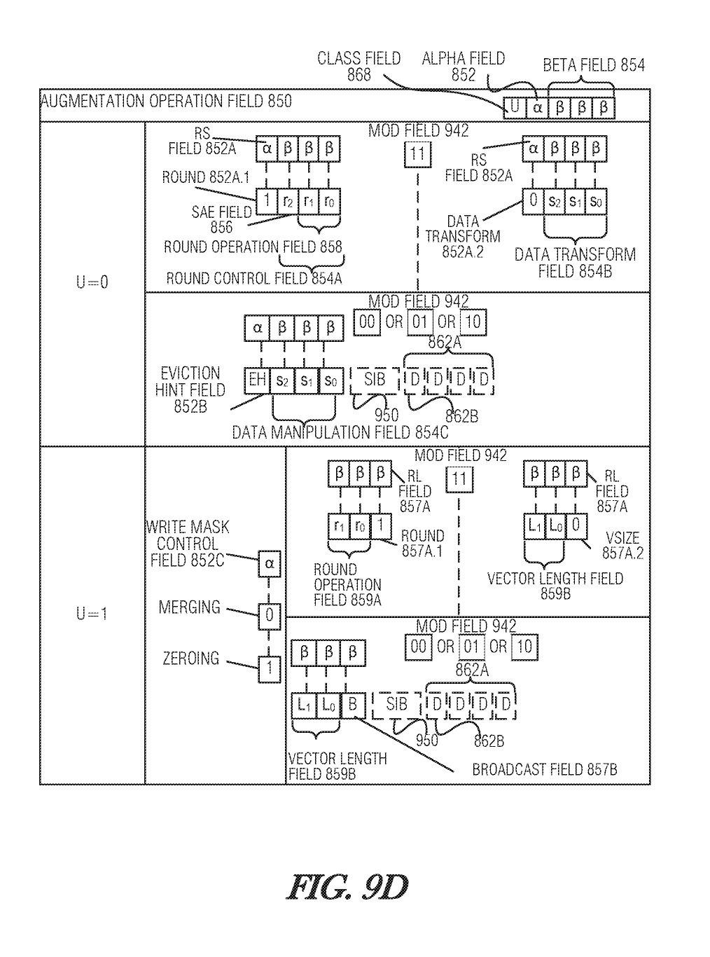

FIG. 9 is a block diagram illustrating a specific vector friendly instruction format according to an embodiment. FIG. 9 shows a specific vector friendly instruction format 900 that is specific in the sense that it specifies the location, size, interpretation, and order of the fields, as well as values for some of those fields. The specific vector friendly instruction format 900 may be used to extend the x86 instruction set, and thus some of the fields are similar or the same as those used in the existing x86 instruction set and extension thereof (e.g., AVX). This format remains consistent with the prefix encoding field, real opcode byte field. MOD R/M field, SIB field, displacement field, and immediate fields of the existing x86 instruction set with extensions. The fields from FIG. 8 into which the fields from FIG. 9 map are illustrated.

It should be understood that, although embodiments are described with reference to the specific vector friendly instruction format 900 in the context of the generic vector friendly instruction format 800 for illustrative purposes, the invention is not limited to the specific vector friendly instruction format 900 except where claimed. For example, the generic vector friendly instruction format 800 contemplates a variety of possible sizes for the various fields, while the specific vector friendly instruction format 900 is shown as having fields of specific sizes. By way of specific example, while the data element width field 864 is illustrated as a one bit field in the specific vector friendly instruction format 900, the invention is not so limited (that is, the generic vector friendly instruction format 800 contemplates other sizes of the data element width field 864).

The generic vector friendly instruction format 800 includes the following fields listed below in the order illustrated in FIG. 9A.

EVEX Prefix (Bytes 0-3) 902—is encoded in a four-byte form.

Format Field 840 (EVEX Byte 0, bits [7:0])—the first byte (EVEX Byte 0) is the format field 840 and it contains 0x62 (the unique value used for distinguishing the vector friendly instruction format in an embodiment).

The second-fourth bytes (EVEX Bytes 1-3) include a number of bit fields providing specific capability.

REX field 905 (EVEX Byte 1, bits [7-5])—consists of an EVEX.R bit field (EVEX Byte 1, bit [7]—R). EVEX.X bit field (EVEX byte 1, bit [6]—X), and 857 BEX byte 1, bit [5]—B). The EVEX.R, EVEX.X, and EVEX.B bit fields provide the same functionality as the corresponding VEX bit fields, and are encoded using Is complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX′ field 810—this is the first part of the REX′ field 810 and is the EVEX.R′ bit field (EVEX Byte 1, bit [4]—R′) that is used to encode either the upper 16 or lower 16 of the extended 32 register set. In an embodiment, this bit, along with others as indicated below, is stored in bit inverted format to distinguish (in the well-known x86 32-bit mode) from the BOUND instruction, whose real opcode byte is 62, but does not accept in the MOD R/M field (described below) the value of 11 in the MOD field; alternative embodiments do not store this and the other indicated bits below in the inverted format. A value of 1 is used to encode the lower 16 registers. In other words. R′Rrrr is formed by combining EVEX.R′, EVEX.R, and the other RRR from other fields.

Opcode map field 915 (EVEX byte 1, bits [3:0]—mmmm)—its content encodes an implied leading opcode byte (0F, 0F 38, or 0F 3).

Data element width field 864 (EVEX byte 2, bit [7]—W)—is represented by the notation EVEX.W. EVEX.W is used to define the granularity (size) of the datatype (either 32-bit data elements or 64-bit data elements).

EVEX.vvvv 920 (EVEX Byte 2, bits [6:3]—vvvv)—the role of EVEX.vvvv may include the following: 1) EVEX.vvvv encodes the first source register operand, specified in inverted (1s complement) form and is valid for instructions with 2 or more source operands; 2) EVEX.vvvv encodes the destination register operand, specified in 1s complement form for certain vector shifts; or 3) EVEX.vvvv does not encode any operand, the field is reserved and should contain 1111b. Thus. EVEX.vvvv field 920 encodes the 4 low-order bits of the first source register specifier stored in inverted (is complement) form. Depending on the instruction, an extra different EVEX bit field is used to extend the specifier size to 32 registers.

EVEX.U 868 Class field (EVEX byte 2, bit [2]—U)—If EVEX.U=0, it indicates class A or EVEX.U0; if EVEX.U=1, it indicates class B or EVEX.U1.

Prefix encoding field 925 (EVEX byte 2, bits [1:0]—pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In an embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 852 (EVEX byte 3, bit [7]—EH: also known as EVEX.EH, EVEX.rs, EVEX.RL, EVEX.write mask control and EVEX.N; also illustrated with a)—as previously described, this field is context specific.

Beta field 854 (EVEX byte 3, bits [6:4]—SSS, also known as EVEX.s2-0, EVEX.r2-0, EVEX.rr1, EVEX.LL0. EVEX.LLB; also illustrated with βββ)—as previously described, this field is context specific.

REX′ field 810—this is the remainder of the REX′ field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 870 (EVEX byte 3, bits [2:0]—kkk)—its content specifies the index of a register in the write mask registers as previously described. In an embodiment, the specific value EVEX.kkk=000 has a special behavior implying no write mask is used for the particular instruction (this may be implemented in a variety of ways including the use of a write mask hardwired to all ones or hardware that bypasses the masking hardware).

Real Opcode Field 930 (Byte 4) is also known as the opcode byte. Part of the opcode is specified in this field.

MOD R/M Field 940 (Byte 5) includes MOD field 942, Reg field 944, and R/M field 946. As previously described, the MOD field's 942 content distinguishes between memory access and non-memory access operations. The role of Reg field 944 can be summarized to two situations: encoding either the destination register operand or a source register operand, or be treated as an opcode extension and not used to encode any instruction operand. The role of R/M field 946 may include the following: encoding the instruction operand that references a memory address, or encoding either the destination register operand or a source register operand.

Scale, Index, Base (SIB) Byte (Byte 6)—As previously described, the scale field's 850 content is used for memory address generation. SIB.xxx 954 and SIB.bbb 956—the contents of these fields have been previously referred to with regard to the register indexes Xxxx and Bbbb.

Displacement field 862A (Bytes 7-10)—when MOD field 942 contains 10, bytes 7-10 are the displacement field 862A, and it works the same as the legacy 32-bit displacement (disp32) and works at byte granularity.

Displacement factor field 862B (Byte 7)—when MOD field 942 contains 01, byte 7 is the displacement factor field 862B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 862B is a reinterpretation of disp8; when using displacement factor field 862B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 862B substitutes the legacy x86 instruction set 8-bit displacement. Thus, the displacement factor field 862B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset). Immediate field 872 operates as previously described.

### Full Opcode Field

FIG. 9B is a block diagram illustrating the fields of the specific vector friendly instruction format 900 that make up the full opcode field 874 according to an embodiment. Specifically, the full opcode field 874 includes the format field 840, the base operation field 842, and the data element width (W) field 864. The base operation field 842 includes the prefix encoding field 925, the opcode map field 915, and the real opcode field 930.

### Register Index Field

FIG. 9C is a block diagram illustrating the fields of the specific vector friendly instruction format 900 that make up the register index field 844 according to an embodiment. Specifically, the register index field 844 includes the REX field 905, the REX′ field 910, the MODR/M.reg field 944, the MODR/M.r/m field 946, the VVVV field 920, xxx field 954, and the bbb field 956.

### Augmentation Operation Field

FIG. 9D is a block diagram illustrating the fields of the specific vector friendly instruction format 900 that make up the augmentation operation field 850 according to an embodiment. When the class (U) field 868 contains 0, it signifies EVEX.U0 (class A 868A); when it contains 1, it signifies EVEX.U1 (class B 868B). When U=0 and the MOD field 942 contains 11 (signifying a no memory access operation), the alpha field 852 (EVEX byte 3, bit [7]—EH) is interpreted as the rs field 852A. When the rs field 852A contains a 1 (round 852A.1), the beta field 854 (EVEX byte 3, bits 16:41—SSS) is interpreted as the round control field 854A. The round control field 854A includes a one bit SAE field 856 and a two bit round operation field 858. When the rs field 852A contains a 0 (data transform 852A.2), the beta field 854 (EVEX byte 3, bits [6:4]—SSS) is interpreted as a three bit data transform field 854B. When U=0 and the MOD field 942 contains 00, 01, or 10 (signifying a memory access operation), the alpha field 852 (EVEX byte 3, bit [7]—EH) is interpreted as the eviction hint (EH) field 852B and the beta field 854 (EVEX byte 3, bits [6:4]—SSS) is interpreted as a three bit data manipulation field 854C.

When U=1, the alpha field 852 (EVEX byte 3, bit [7]—EH) is interpreted as the write mask control (Z) field 852C. When U=1 and the MOD field 942 contains 11 (signifying a no memory access operation), part of the beta field 854 (EVEX byte 3, bit [4]—SO) is interpreted as the RL field 857A; when it contains a 1 (round 857A.1) the rest of the beta field 854 (EVEX byte 3, bit [6-5]—S2-1) is interpreted as the round operation field 859A, while when the RL field 857A contains a 0 (VSIZE 857.A2) the rest of the beta field 854 (EVEX byte 3, bit [6-5]—S2-1) is interpreted as the vector length field 859B (EVEX byte 3, bit [6-5]—L1-0). When U=1 and the MOD field 942 contains 00, 01, or 10 (signifying a memory access operation), the beta field 854 (EVEX byte 3, bits [6:4]—SSS) is interpreted as the vector length field 859B (EVEX byte 3, bit [6-5]—L1-0) and the broadcast field 857B (EVEX byte 3, bit [4]—B).

### Register Architecture

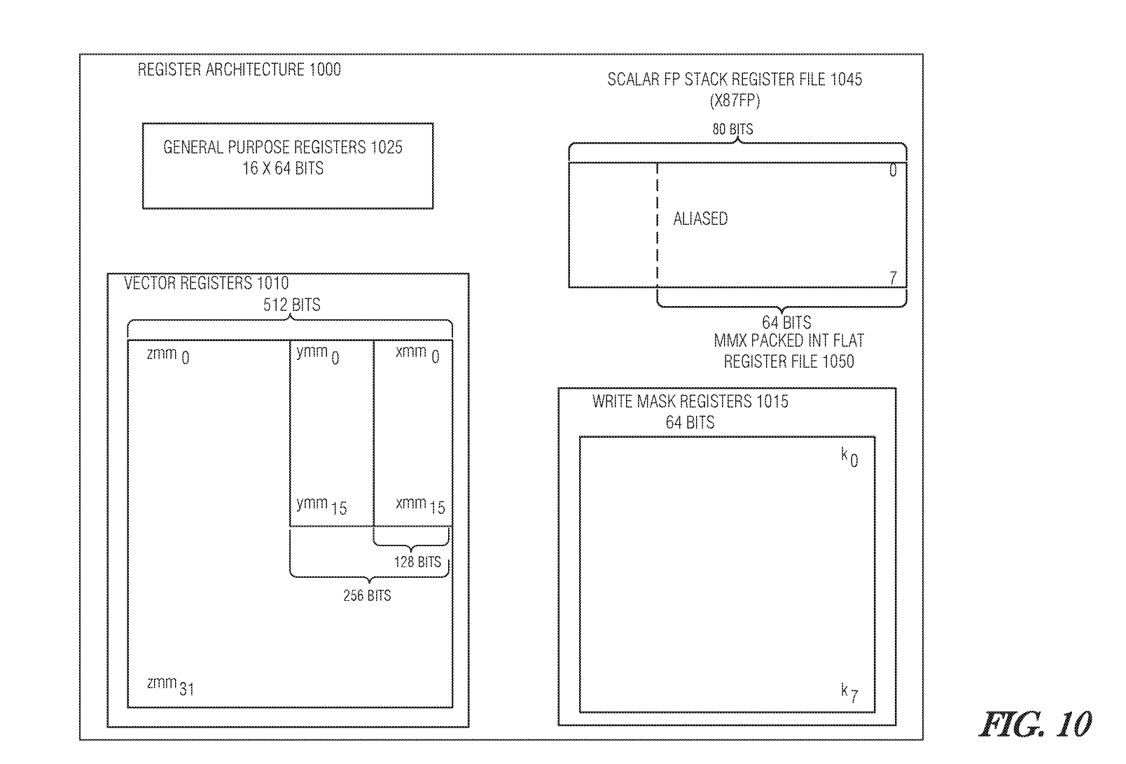

FIG. 10 is a block diagram of a register architecture 1000 according to an embodiment. In the embodiment illustrated, there are 32 vector registers 1010 that are 512 bits wide; these registers are referenced as zmm0 through zmm31. The lower order 256 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 900 operates on these overlaid register file as illustrated in the below tables.

| Adjustable Vector | | | |
|---|---|---|---|
| Length | Class | Operations | Registers |
| Instruction | A (FIG. | 810, 815, | zmm registers (the vector |
| Templates that | 8A; | 825, 830 | length is 64 byte) |
| do not include the | U = 0) | | |
| vector length field | B (FIG. | 812 | zmm registers (the vector |
| 859B | 8B; | | length is 64 byte) |
| | U = 1) | | |
| Instruction | B (FIG. | 817, 827 | zmm, ymm, or xmm registers |
| templates that | 8B; | | (the vector length is 64 byte, |
| do include the | U = 1) | | 32 byte, or 16 byte) |
| vector length field | | | depending on the vector |
| 859B | | | length field 859B |

In other words, the vector length field 859B selects between a maximum length and one or more other shorter lengths, where each such shorter length is half the length of the preceding length; and instructions templates without the vector length field 859B operate on the maximum vector length. Further, in an embodiment, the class B instruction templates of the specific vector friendly instruction format 900 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 1015—in the embodiment illustrated, there are 8 write mask registers (k0 through k7), each 64 bits in size. In an alternate embodiment, the write mask registers 1015 are 16 bits in size. As previously described, in an embodiment, the vector mask register k0 cannot be used as a write mask; when the encoding that would normally indicate k0 is used for a write mask, it selects a hardwired write mask of 0xFFFF, effectively disabling write masking for that instruction.

General-purpose registers 1025—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 1045, on which is aliased the MMX packed integer flat register file 1050—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Alternative embodiments may use wider or narrower registers. Additionally, alternative embodiments may use more, less, or different register files and registers.

### Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Core architectures are described next, followed by descriptions of processors and computer architectures.

### Core Architectures

In-Order and Out-of-Order Core Block Diagram

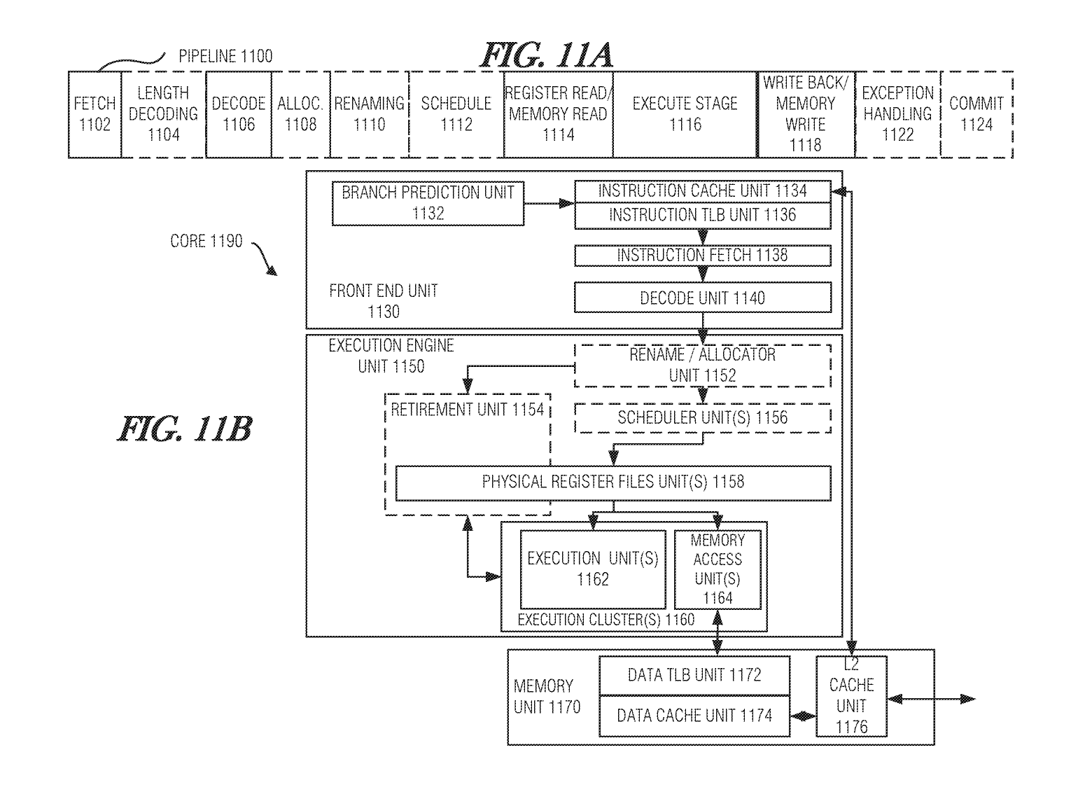

FIG. 11A is a block diagram illustrating both an in-order pipeline and a register renaming, out-of-order issue/execution pipeline according to embodiments. FIG. 11B is a block diagram illustrating both an embodiment of an in-order architecture core and a register renaming, out-of-order issue/execution architecture core to be included in a processor according to an embodiment. The solid lined boxes in FIGS. 11A-11B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 11A, a processor pipeline 1100 includes a fetch stage 1102, a length decode stage 1104, a decode stage 1106, an allocation stage 1108, a renaming stage 1110, a scheduling (also known as a dispatch or issue) stage 1112, a register read/memory read stage 1114, an execute stage 1116, a write back/memory write stage 1118, an exception handling stage 1122, and a commit stage 1124.

FIG. 11B shows processor core 1190 including a front end unit 1130 coupled to an execution engine unit 1150, and both are coupled to a memory unit 1170. The core 1190 may be a reduced instruction set computing (RISC) core, a complex instruction set computing (CISC) core, a very long instruction word (VLIW) core, or a hybrid or alternative core type. As yet another option, the core 1190 may be a special-purpose core, such as, for example, a network or communication core, compression engine, coprocessor core, general purpose computing graphics processing unit (GPGPU) core, graphics core, or the like.

The front end unit 1130 includes a branch prediction unit 1132 coupled to an instruction cache unit 1134, which is coupled to an instruction translation lookaside buffer (TLB) 1136, which is coupled to an instruction fetch unit 1138, which is coupled to a decode unit 1140. The decode unit 1140 (or decoder) may decode instructions, and generate as an output one or more micro-operations, micro-code entry points, microinstructions, other instructions, or other control signals, which are decoded from, or which otherwise reflect, or are derived from, the original instructions. The decode unit 1140 may be implemented using various different mechanisms. Examples of suitable mechanisms include, but are not limited to, look-up tables, hardware implementations, programmable logic arrays (PLAs), microcode read only memories (ROMs), etc. In an embodiment, the core 1190 includes a microcode ROM or other medium that stores microcode for certain macroinstructions (e.g., in decode unit 1140 or otherwise within the front end unit 1130). The decode unit 1140 is coupled to a rename/allocator unit 1152 in the execution engine unit 1150.

The execution engine unit 1150 includes the rename/allocator unit 1152 coupled to a retirement unit 1154 and a set of one or more scheduler unit(s) 1156. The scheduler unit(s) 1156 represents any number of different schedulers, including reservations stations, central instruction window, etc. The scheduler unit(s) 1156 is coupled to the physical register file(s) unit(s) 1158. Each of the physical register file(s) units 1158 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In an embodiment, the physical register file(s) unit 1158 comprises a vector registers unit, a write mask registers unit, and a scalar registers unit. These register units may provide architectural vector registers, vector mask registers, and general purpose registers. The physical register file(s) unit(s) 1158 is overlapped by the retirement unit 1154 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 1154 and the physical register file(s) unit(s) 1158 are coupled to the execution cluster(s) 1160. The execution cluster(s) 1160 includes a set of one or more execution units 1162 and a set of one or more memory access units 1164. The execution units 1162 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1156, physical register file(s) unit(s) 1158, and execution cluster(s) 1160 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1164). It should also be understood that where separate pipelines are used, one or more of these pipelines may be out-of-order issue/execution and the rest in-order.

The set of memory access units 1164 is coupled to the memory unit 1170, which includes a data TLB unit 1172 coupled to a data cache unit 1174 coupled to a level 2 (L2) cache unit 1176. In an embodiment, the memory access units 1164 may include a load unit, a store address unit, and a store data unit, each of which is coupled to the data TLB unit 1172 in the memory unit 1170. The instruction cache unit 1134 is further coupled to a level 2 (L2) cache unit 1176 in the memory unit 1170. The L2 cache unit 1176 is coupled to one or more other levels of cache and eventually to a main memory.

By way of example, the register renaming, out-of-order issue/execution core architecture may implement the pipeline 1100 as follows: 1) the instruction fetch 1138 performs the fetch and length decoding stages 1102 and 1104; 2) the decode unit 1140 performs the decode stage 1106; 3) the rename/allocator unit 1152 performs the allocation stage 1108 and renaming stage 1110; 4) the scheduler unit(s) 1156 performs the schedule stage 1112; 5) the physical register file(s) unit(s) 1158 and the memory unit 1170 perform the register read/memory read stage 1114: the execution cluster 1160 perform the execute stage 1116; 6) the memory unit 1170 and the physical register file(s) unit(s) 1158 perform the write back/memory write stage 1118; 7) various units may be involved in the exception handling stage 1122; and 8) the retirement unit 1154 and the physical register file(s) unit(s) 1158 perform the commit stage 1124.

The core 1190 may support one or more instructions sets (e.g., the x86 instruction set (with some extensions that have been added with newer versions): the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In an embodiment, the core 1190 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1134/1174 and a shared L2 cache unit 1176, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific In-Order Core Architecture

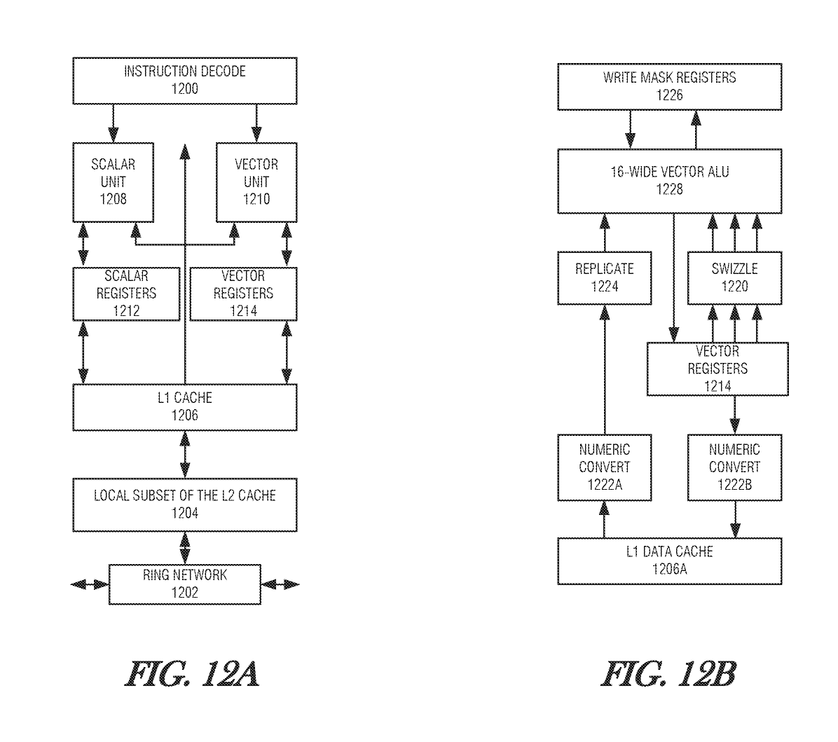

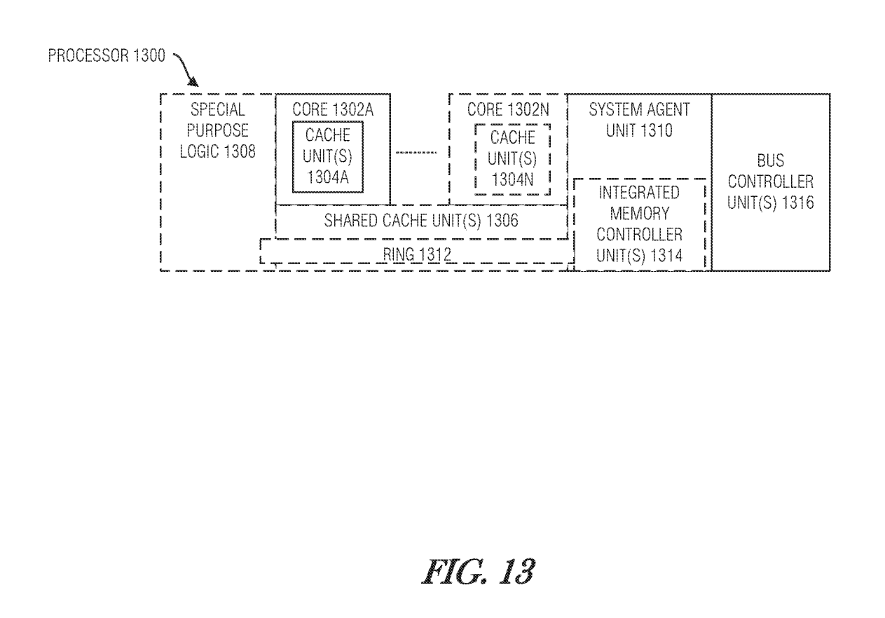

FIGS. 12A-12B illustrate a block diagram of a more specific in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 12A is a block diagram of a single processor core, along with its connection to the on-die interconnect network 1202 and with its local subset of the Level 2 (L2) cache 1204, according to an embodiment. In an embodiment, an instruction decoder 1200 supports the x86 instruction set with a packed data instruction set extension. An L1 cache 1206 allows low-latency accesses to cache memory into the scalar and vector units. While in one embodiment (to simplify the design), a scalar unit 1208 and a vector unit 1210 use separate register sets (respectively, scalar registers 1212 and vector registers 1214) and data transferred between them is written to memory and then read back in from a level 1 (L1) cache 1206, alternative embodiments may use a different approach (e.g., use a single register set or include a communication path that allow data to be transferred between the two register files without being written and read back).

The local subset of the L2 cache 1204 is part of a global L2 cache that is divided into separate local subsets, one per processor core. Each processor core has a direct access path to its own local subset of the L2 cache 1204. Data read by a processor core is stored in its L2 cache subset 1204 and can be accessed quickly, in parallel with other processor cores accessing their own local L2 cache subsets. Data written by a processor core is stored in its own L2 cache subset 1204 and is flushed from other subsets, if necessary. The ring network ensures coherency for shared data. The ring network is bi-directional to allow agents such as processor cores. L2 caches and other logic blocks to communicate with each other within the chip. Each ring data-path is 1012-bits wide per direction.

FIG. 12B is an expanded view of part of the processor core in FIG. 12A according to an embodiment. FIG. 12B includes an L1 data cache 1206A part of the L1 cache 1204, as well as more detail regarding the vector unit 1210 and the vector registers 1214. Specifically, the vector unit 1210 is a 16-wide vector processing unit (VPU) (see the 16-wide ALU 1228), which executes one or more of integer, single-precision float, and double-precision float instructions. The VPU supports swizzling the register inputs with swizzle unit 1220, numeric conversion with numeric convert units 1222A-B. and replication with replication unit 1224 on the memory input. Write mask registers 1226 allow predicating resulting vector writes.

FIG. 13 is a block diagram of a processor 1300 that may have more than one core, may have an integrated memory controller, and may have integrated graphics according to embodiments. The solid lined boxes in FIG. 13 illustrate a processor 1300 with a single core 1302A, a system agent 1310, a set of one or more bus controller units 1316, while the optional addition of the dashed lined boxes illustrates an alternative processor 1300 with multiple cores 1302A-N, a set of one or more integrated memory controller unit(s) 1314 in the system agent unit 1310, and special purpose logic 1308.

Thus, different implementations of the processor 1300 may include: 1) a CPU with the special purpose logic 1308 being integrated graphics and/or scientific (throughput) logic (which may include one or more cores), and the cores 1302A-N being one or more general purpose cores (e.g., general purpose in-order cores, general purpose out-of-order cores, a combination of the two); 2) a coprocessor with the cores 1302A-N being a large number of special purpose cores intended primarily for graphics and/or scientific (throughput); and 3) a coprocessor with the cores 1302A-N being a large number of general purpose in-order cores. Thus, the processor 1300 may be a general-purpose processor, coprocessor or special-purpose processor, such as, for example, a network or communication processor, compression engine, graphics processor. GPGPU (general purpose graphics processing unit), a high-throughput many integrated core (MIC) coprocessor (including 30 or more cores), embedded processor, or the like. The processor may be implemented on one or more chips. The processor 1300 may be a part of and/or may be implemented on one or more substrates using any of a number of process technologies, such as, for example, BiCMOS. CMOS, or NMOS.

The memory hierarchy includes one or more levels of cache within the cores, a set or one or more shared cache units 1306, and external memory (not shown) coupled to the set of integrated memory controller units 1314. The set of shared cache units 1306 may include one or more mid-level caches, such as level 2 (L2), level 3 (L3), level 4 (L4), or other levels of cache, a last level cache (LLC), and/or combinations thereof. While in one embodiment a ring based interconnect unit 1312 interconnects the integrated graphics logic 1308, the set of shared cache units 1306, and the system agent unit 1310/integrated memory controller unit(s) 1314, alternative embodiments may use any number of well-known techniques for interconnecting such units. In an embodiment, coherency is maintained between one or more cache units 1304A-N and cores 1302A-N.

In some embodiments, one or more of the cores 1302A-N are capable of multi-threading. The system agent 1310 includes those components coordinating and operating cores 1302A-N. The system agent unit 1310 may include for example a power control unit (PCU) and a display unit. The PCU may be or include logic and components needed for regulating the power state of the cores 1302A-N and the integrated graphics logic 1308. The display unit is for driving one or more externally connected displays.

The cores 1302A-N may be homogenous or heterogeneous in terms of architecture instruction set; that is, two or more of the cores 1302A-N may be capable of execution the same instruction set, while others may be capable of executing only a subset of that instruction set or a different instruction set.

### Computer Architectures

FIGS. 14-17 are block diagrams of computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 14, shown is a block diagram of a system 1400 according to an embodiment. The system 1400 may include one or more processors 1410, 1415, which are coupled to a controller hub 1420. In an embodiment the controller hub 1420 includes a graphics memory controller hub (GMCH) 1490 and an Input/Output Hub (IOH) 1450 (which may be on separate chips): the GMCH 1490 includes memory and graphics controllers to which are coupled memory 1440 and a coprocessor 1445; the IOH 1450 is couples input/output (I/O) devices 1460 to the GMCH 1490. Alternatively, one or both of the memory and graphics controllers are integrated within the processor (as described herein), the memory 1440 and the coprocessor 1445 are coupled directly to the processor 1410, and the controller hub 1420 in a single chip with the IOH 1450.

The optional nature of additional processors 1415 is denoted in FIG. 14 with broken lines. Each processor 1410, 1415 may include one or more of the processing cores described herein and may be some version of the processor 1300.

The memory 1440 may be, for example, dynamic random access memory (DRAM), phase change memory (PCM), or a combination of the two. For at least one embodiment, the controller hub 1420 communicates with the processor(s) 1410, 1415 via a multi-drop bus, such as a frontside bus (FSB), point-to-point interface such as QuickPath Interconnect (QPI), or similar connection 1495.

In an embodiment, the coprocessor 1445 is a special-purpose processor, such as, for example, a high-throughput MIC processor, a network or communication processor, compression engine, graphics processor, GPGPU, embedded processor, or the like. In an embodiment, controller hub 1420 may include an integrated graphics accelerator.

There can be a variety of differences between the physical resources 1410, 1415 in terms of a spectrum of metrics of merit including architectural, microarchitectural, thermal, power consumption characteristics, and the like.

In an embodiment, the processor 1410 executes instructions that control data processing operations of a general type. Embedded within the instructions may be coprocessor instructions. The processor 1410 recognizes these coprocessor instructions as being of a type that should be executed by the attached coprocessor 1445. Accordingly, the processor 1410 issues these coprocessor instructions (or control signals representing coprocessor instructions) on a coprocessor bus or other interconnect, to coprocessor 1445. Coprocessor(s) 1445 accept and execute the received coprocessor instructions.

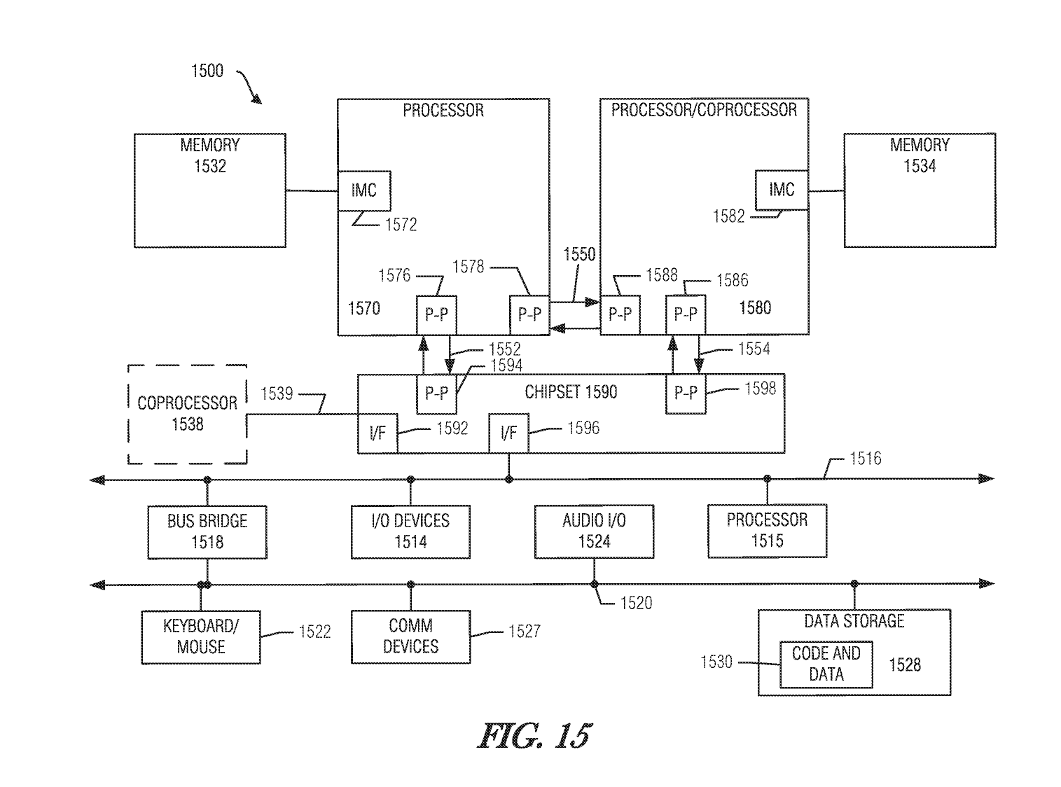

Referring now to FIG. 15, shown is a block diagram of a first more specific system 1500 in accordance with an embodiment. As shown in FIG. 15, multiprocessor system 1500 is a point-to-point interconnect system, and includes a first processor 1570 and a second processor 1580 coupled via a point-to-point interconnect 1550. Each of processors 1570 and 1580 may be some version of the processor 1300. In an embodiment, processors 1570 and 1580 are respectively processors 1410 and 1415, while coprocessor 1538 is coprocessor 1445. In another embodiment, processors 1570 and 1580 are respectively processor 1410 coprocessor 1445.

Processors 1570 and 1580 are shown including integrated memory controller (IMC) units 1572 and 1582, respectively. Processor 1570 also includes as part of its bus controller units point-to-point (P-P) interfaces 1576 and 1578; similarly, second processor 1580 includes P-P interfaces 1586 and 1588. Processors 1570, 1580 may exchange information via a point-to-point (P-P) interface 1550 using P-P interface circuits 1578, 1588. As shown in FIG. 15. IMCs 1572 and 1582 couple the processors to respective memories, namely a memory 1532 and a memory 1534, which may be portions of main memory locally attached to the respective processors.

Processors 1570, 1580 may each exchange information with a chipset 1590 via individual P-P interfaces 1552, 1554 using point to point interface circuits 1576, 1594, 1586, 1598. Chipset 1590 may optionally exchange information with the coprocessor 1538 via a high-performance interface 1539. In an embodiment, the coprocessor 1538 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1590 may be coupled to a first bus 1516 via an interface 1596. In an embodiment, first bus 1516 may be a Peripheral Component Interconnect (PCI) bus, or a bus such as a PCI Express bus or another third generation I/O interconnect bus, although the scope of the present invention is not so limited.

As shown in FIG. 15, various I/O devices 1514 may be coupled to first bus 1516, along with a bus bridge 1518 which couples first bus 1516 to a second bus 1520. In an embodiment, one or more additional processor(s) 1515, such as coprocessors, high-throughput MIC processors. GPGPU's, accelerators (such as, e.g., graphics accelerators or digital signal processing (DSP) units), field programmable gate arrays, or any other processor, are coupled to first bus 1516. In an embodiment, second bus 1520 may be a low pin count (LPC) bus. Various devices may be coupled to a second bus 1520 including, for example, a keyboard and/or mouse 1522, communication devices 1527 and a storage unit 1528 such as a disk drive or other mass storage device which may include instructions/code and data 1530, in an embodiment. Further, an audio I/O 1524 may be coupled to the second bus 1520. Note that other architectures are possible. For example, instead of the point-to-point architecture of FIG. 15, a system may implement a multi-drop bus or other such architecture.

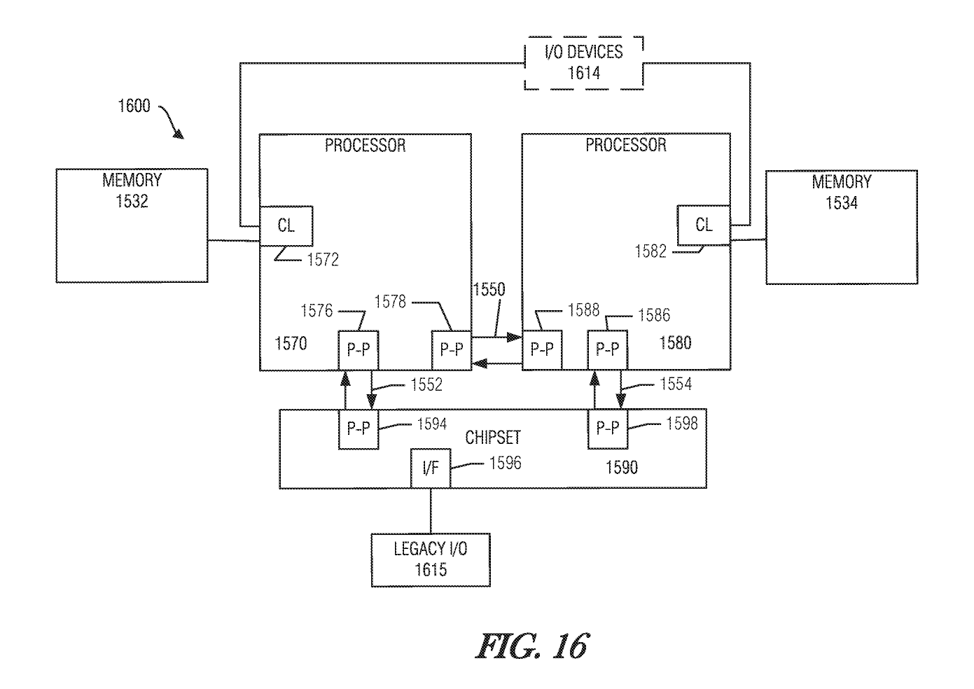

Referring now to FIG. 16, shown is a block diagram of a second more specific system 1600 in accordance with an embodiment. Like elements in FIGS. 15 and 16 bear like reference numerals, and certain aspects of FIG. 15 have been omitted from FIG. 16 in order to avoid obscuring other aspects of FIG. 16.

FIG. 16 illustrates that the processors 1570, 1580 may include integrated memory and I/O control logic (“CL”) 1572 and 1582, respectively. Thus, the CL 1572, 1582 include integrated memory controller units and include I/O control logic. FIG. 16 illustrates that not only are the memories 1532, 1534 coupled to the CL 1572, 1582, but also that I/O devices 1614 are also coupled to the control logic 1572, 1582. Legacy I/O devices 1615 are coupled to the chipset 1590.

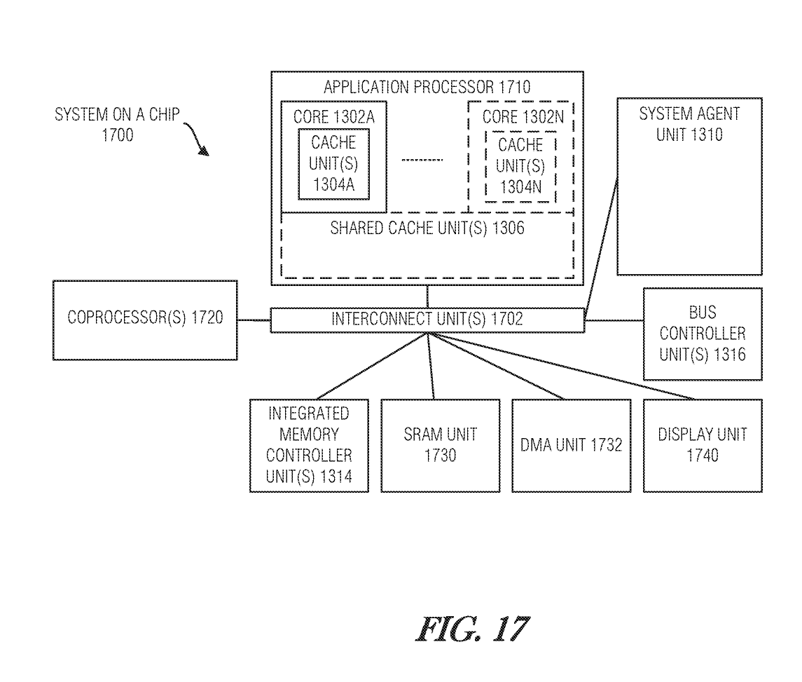

Referring now to FIG. 17, shown is a block diagram of a SoC 1700 in accordance with an embodiment. Similar elements in FIG. 13 bear like reference numerals. Also, dashed lined boxes are optional features on more advanced SoCs. In FIG. 17, an interconnect unit(s) 1702 is coupled to: an application processor 1710 which includes a set of one or more cores 1302A-N with integrated cache units 1304A-N and shared cache unit(s) 1306; a system agent unit 1310: a bus controller unit(s) 1316: an integrated memory controller unit(s) 1314; a set or one or more coprocessors 1720 which may include integrated graphics logic, an image processor, an audio processor, and a video processor; an static random access memory (SRAM) unit 1730: a direct memory access (DMA) unit 1732; and a display unit 1740 for coupling to one or more external displays. In an embodiment, the coprocessor(s) 1720 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1530 illustrated in FIG. 15, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

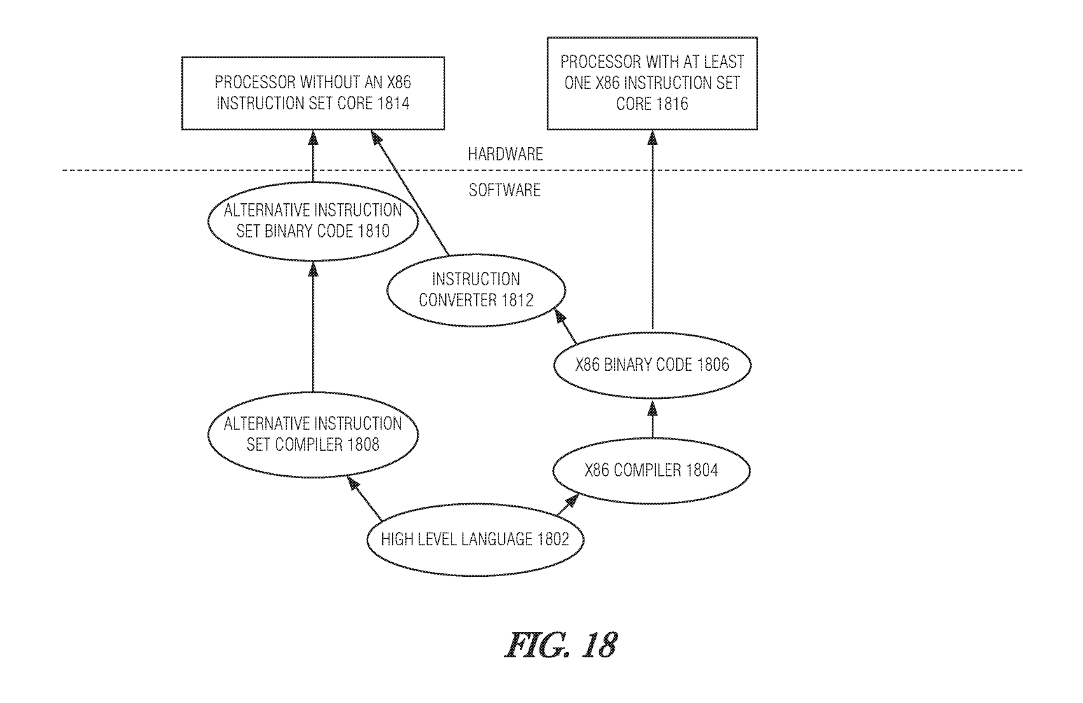

FIG. 18 is a block diagram contrasting the use of a software instruction converter to convert binary instructions in a source instruction set to binary instructions in a target instruction set according to embodiments. In the illustrated embodiment, the instruction converter is a software instruction converter, although alternatively the instruction converter may be implemented in software, firmware, hardware, or various combinations thereof. FIG. 18 shows a program in a high level language 1802 may be compiled using an x86 compiler 1804 to generate x86 binary code 1806 that may be natively executed by a processor with at least one x86 instruction set core 1816. The processor with at least one x86 instruction set core 1816 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1804 represents a compiler that is operable to generate x86 binary code 1806 (e.g., object code) that can, with or without additional linkage processing, be executed on the processor with at least one x86 instruction set core 1816. Similarly, FIG. 18 shows the program in the high level language 1802 may be compiled using an alternative instruction set compiler 1808 to generate alternative instruction set binary code 1810 that may be natively executed by a processor without at least one x86 instruction set core 1814 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1812 is used to convert the x86 binary code 1806 into code that may be natively executed by the processor without an x86 instruction set core 1814. This converted code is not likely to be the same as the alternative instruction set binary code 1810 because an instruction converter capable of this is difficult to make; however, the converted code will accomplish the general operation and be made up of instructions from the alternative instruction set. Thus, the instruction converter 1812 represents software, firmware, hardware, or a combination thereof that, through emulation, simulation or any other process, allows a processor or other electronic device that does not have an x86 instruction set processor or core to execute the x86 binary code 1806.

### Additional Notes & Examples

Example 1 is a system for computer memory management, the system comprising: monitoring circuitry to produce a rate exceeded signal that indicates that memory traffic flow from a traffic source exceeds a threshold; and rate control circuitry that includes, throttle circuitry, the rate control circuitry to: receive the rate exceeded signal from the monitoring circuitry; receive a distress signal from a memory controller that interfaces with a memory device, the distress signal indicating that the memory device is oversubscribed; and invoke the throttle circuitry to throttle the memory traffic flow from the traffic source when the rate exceeded signal and the distress signal are both asserted.

In Example 2, the subject matter of Example 1 includes, wherein the rate control circuitry includes a control signal to enable or disable the throttle circuitry regardless of whether the rate exceeded signal or the distress signal are asserted.

In Example 3, the subject matter of Examples 1-2 includes, wherein the monitoring circuitry uses a leaky-bucket algorithm to determine whether to assert the rate exceeded signal.

In Example 4, the subject matter of Examples 1-3 includes, wherein the monitoring circuitry includes a request counter to maintain a counter of how many requests are received in a time period.

In Example 5, the subject matter of Example 4 includes, wherein the time period is a number of clock cycles.

In Example 6, the subject matter of Example 5 includes, wherein the time period is measured using a time-window counter, the time-window counter configured to count down from a predetermined value at each clock cycle and cause the request counter to reset.

In Example 7, the subject matter of Examples 1-6 includes, wherein the rate control circuitry is configured to not throttle response traffic to the traffic source.

In Example 8, the subject matter of Examples 1-7 includes, wherein the throttle control circuitry implements a fixed throttle rate.

In Example 9, the subject matter of Examples 1-8 includes, wherein the throttle circuitry implements a variable throttle rate.

In Example 10, the subject matter of Example 9 includes, wherein the variable throttle rate is a function of a number of active cores in a system.

In Example 11, the subject matter of Examples 1-10 includes, wherein the memory controller that interfaces with the memory device implements memory deduplication.

Example 12 is a method of computer memory management, the method comprising: receiving a rate exceeded signal, the rate exceeded signal indicating that memory traffic flow from a traffic source exceeds a threshold; receiving a distress signal from a memory controller that interfaces with a memory device, the distress signal indicating that the memory device is oversubscribed; and throttling the memory traffic flow from the traffic source when the rate exceeded signal and the distress signal are both asserted.

In Example 13, the subject matter of Example 12 includes, receiving a control signal to enable or disable the throttling regardless of whether the rate exceeded signal or the distress signal are asserted.

In Example 14, the subject matter of Examples 12-13 includes, using a leaky-bucket algorithm to determine whether to assert the rate exceeded signal.

In Example 15, the subject matter of Examples 12-14 includes, maintaining a request counter, the request counter to track how many requests are received in a time period.

In Example 16, the subject matter of Example 15 includes, wherein the time period is a number of clock cycles.

In Example 17, the subject matter of Example 16 includes, wherein the time period is measured using a time-window counter, the time-window counter configured to count down from a predetermined value at each clock cycle and cause the request counter to reset.

In Example 18, the subject matter of Examples 12-17 includes, not throttling response traffic to the traffic source.

In Example 19, the subject matter of Examples 12-18 includes, wherein throttling the memory traffic flow from the traffic source includes using a fixed throttle rate.

In Example 20, the subject matter of Examples 12-19 includes, wherein throttling the memory traffic flow from the traffic source includes using a variable throttle rate.

In Example 21, the subject matter of Example 20 includes, wherein the variable throttle rate is a function of a number of active cores in a system.

In Example 22, the subject matter of Examples 12-21 includes, wherein the memory controller that interfaces with the memory device implements memory deduplication.

Example 23 is at least one non-transitory machine-readable medium including instructions for computer memory management, the instructions when executed by a machine, cause the machine to perform the operations comprising: receiving a rate exceeded signal the rate exceeded signal indicating that memory traffic flow from a traffic source exceeds a threshold; receiving a distress signal from a memory controller that interfaces with a memory device, the distress signal indicating that the memory device is oversubscribed; and throttling the memory traffic flow from the traffic source when the rate exceeded signal and the distress signal are both asserted.

In Example 24, the subject matter of Example 23 includes, receiving a control signal to enable or disable the throttling regardless of whether the rate exceeded signal or the distress signal are asserted.

In Example 25, the subject matter of Examples 23-24 includes, using a leaky-bucket algorithm to determine whether to assert the rate exceeded signal.

In Example 26, the subject matter of Examples 23-25 includes, maintaining a request counter, the request counter to track how many requests are received in a time period.

In Example 27, the subject matter of Example 26 includes, wherein the time period is a number of clock cycles.

In Example 28, the subject matter of Example 27 includes, wherein the time period is measured using a time-window counter, the time-window counter configured to count down from a predetermined value at each clock cycle and cause the request counter to reset.

In Example 29, the subject matter of Examples 23-28 includes, not throttling response traffic to the traffic source.

In Example 30, the subject matter of Examples 23-29 includes, wherein throttling the memory traffic flow from the traffic source includes using a fixed throttle rate.

In Example 31, the subject matter of Examples 23-30 includes, wherein throttling the memory traffic flow from the traffic source includes using a variable throttle rate.

In Example 32, the subject matter of Example 31 includes, wherein the variable throttle rate is a function of a number of active cores in a system.

In Example 33, the subject matter of Examples 23-32 includes, wherein the memory controller that interfaces with the memory device implements memory deduplication.

Example 34 is an apparatus for computer memory management, the apparatus comprising: means for receiving a rate exceeded signal, the rate exceeded signal indicating that memory traffic flow from a traffic source exceeds a threshold: means for receiving a distress signal from a memory controller that interfaces with a memory device, the distress signal indicating that the memory device is oversubscribed: and means for throttling the memory traffic flow from the traffic source when the rate exceeded signal and the distress signal are both asserted.

In Example 35, the subject matter of Example 34 includes, means for receiving a control signal to enable or disable the throttling regardless of whether the rate exceeded signal or the distress signal are asserted.

In Example 36, the subject matter of Examples 34-35 includes, means for using a leaky-bucket algorithm to determine whether to assert the rate exceeded signal.

In Example 37, the subject matter of Examples 34-36 includes, means for maintaining a request counter, the request counter to track how many requests are received in a time period.

In Example 38, the subject matter of Example 37 includes, wherein the time period is a number of clock cycles.

In Example 39, the subject matter of Example 38 includes, wherein the time period is measured using a time-window counter, the time-window counter configured to count down from a predetermined value at each clock cycle and cause the request counter to reset.

In Example 40, the subject matter of Examples 34-39 includes, means for not throttling response traffic to the traffic source.

In Example 41, the subject matter of Examples 34-40 includes, wherein the means for throttling the memory traffic flow from the traffic source include means for using a fixed throttle rate.

In Example 42, the subject matter of Examples 34-41 includes, wherein the means for throttling the memory traffic flow from the traffic source include means for using a variable throttle rate.

In Example 43, the subject matter of Example 42 includes, wherein the variable throttle rate is a function of a number of active cores in a system.

In Example 44, the subject matter of Examples 34-43 includes, wherein the memory controller that interfaces with the memory device implements memory deduplication.

Example 45 is at least one machine-readable medium including instructions that, when executed by processing circuitry, cause the processing circuitry to perform operations to implement of any of Examples 1-44.

Example 46 is an apparatus comprising means to implement of any of Examples 1-44.

Example 47 is a system to implement of any of Examples 1-44.

Example 48 is a method to implement of any of Examples 1-44.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second.” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A system for computer memory management, the system comprising:
monitoring circuitry to produce a rate exceeded signal that indicates that memory traffic flow from a traffic source exceeds a threshold; and
rate control circuitry that includes throttle circuitry, the rate control circuitry to:
receive the rate exceeded signal from the monitoring circuitry;
receive a distress signal from a memory controller that interfaces with a memory device, the distress signal indicating that the memory device is oversubscribed; and
invoke the throttle circuitry to throttle the memory traffic flow from the traffic source when the rate exceeded signal and the distress signal are both asserted.

2. The system of claim 1, wherein the rate control circuitry includes a control signal to enable or disable the throttle circuitry regardless of whether the rate exceeded signal or the distress signal are asserted.

3. The system of claim 1, wherein the monitoring circuitry uses a leaky-bucket algorithm to determine whether to assert the rate exceeded signal.

4. The system of claim 1, wherein the monitoring circuitry includes a request counter to maintain a counter of how many requests are received in a time period.

5. The system of claim 4, wherein the time period is a number of clock cycles.

6. The system of claim 5, wherein the time period is measured using a time-window counter, the time-window counter configured to count down from a predetermined value at each clock cycle and cause the request counter to reset.

7. The system of claim 1, wherein the rate control circuitry is configured to not throttle response traffic to the traffic source.

8. The system of claim 1, wherein the throttle control circuitry implements a fixed throttle rate.

9. The system of claim 1, wherein the throttle circuitry implements a variable throttle rate.

10. The system of claim 9, wherein the variable throttle rate is a function of a number of active cores in a system.

11. The system of claim 1, wherein the memory controller that interfaces with the memory device implements memory deduplication.

12. A method of computer memory management, the method comprising:
receiving a rate exceeded signal, the rate exceeded signal indicating that memory traffic flow from a traffic source exceeds a threshold;
receiving a distress signal from a memory controller that interfaces with a memory device, the distress signal indicating that the memory device is oversubscribed; and
throttling the memory traffic flow from the traffic source when the rate exceeded signal and the distress signal are both asserted.

13. The method of claim 12, further comprising receiving a control signal to enable or disable the throttling regardless of whether the rate exceeded signal or the distress signal are asserted.

14. The method of claim 12, further comprising using a leaky-bucket algorithm to determine whether to assert the rate exceeded signal.

15. The method of claim 12, further comprising maintaining a request counter, the request counter to track how many requests are received in a time period.

16. The method of claim 15, wherein the time period is a number of clock cycles.

17. The method of claim 16, wherein the time period is measured using a time-window counter, the time-window counter configured to count down from a predetermined value at each clock cycle and cause the request counter to reset.

18. The method of claim 12, further comprising not throttling response traffic to the traffic source.

19. The method of claim 12, wherein throttling the memory traffic flow from the traffic source includes using a fixed throttle rate.

20. The method of claim 12, wherein throttling the memory traffic flow from the traffic source includes using a variable throttle rate.

21. The method of claim 20, wherein the variable throttle rate is a function of a number of active cores in a system.

22. The method of claim 12, wherein the memory controller that interfaces with the memory device implements memory deduplication.

23. At least one non-transitory machine-readable medium including instructions for computer memory management, the instructions when executed by a machine, cause the machine to perform the operations comprising:
receiving a rate exceeded signal, the rate exceeded signal indicating that memory traffic flow from a traffic source exceeds a threshold:
receiving a distress signal from a memory controller that interfaces with a memory device, the distress signal indicating that the memory device is oversubscribed; and
throttling the memory traffic flow from the traffic source when the rate exceeded signal and the distress signal are both asserted.

24. The machine-readable medium of claim 23, further comprising receiving a control signal to enable or disable the throttling regardless of whether the rate exceeded signal or the distress signal are asserted.

25. The machine-readable medium of claim 23, further comprising using a leaky-bucket algorithm to determine whether to assert the rate exceeded signal.
